(19) United States
(12) Patent Application Publication
(10) Pub. No.: US 2017/0145627 A1
(43) Pub. Date: May 25, 2017

(54) Reinforcing Fiber Bundle and Method for Producing Same

(71) Applicant: Teijin Limited, Osaka-Shi, Osaka (JP)

(72) Inventors: Hiroshi Sakurai, Osaka-shi (JP); Hiroshi Kimura, Osaka-shi (JP); Yutaka Kondou, Osaka-shi (JP); Takeshi Naito, Osaka-shi (JP)

(73) Assignee: Teijin Limited, Osaka-Shi, Osaka (JP)

(21) Appl. No.: 15/319,415

(22) PCT Filed: Jun. 11, 2015
(86) PCT No.: PCT/JP2015/066906

§ 371 Date: Dec. 16, 2016

(30) Foreign Application Priority Data
Jun. 16, 2014 (JP) 2014-123441
Oct. 9, 2014 (JP) 2014-208129

(51) Int. Cl. D06M 15/59; D06M 15/564; C08J 5/04

(52) U.S. Cl. CPC D06M 15/59; C08J 5/042; D06M 15/564; C08J 2377/06; D06M 2101/40

(57) ABSTRACT

A fiber reinforcing bundle with a sizing agent adhering to the surface thereof is provided, in which the sizing agent contains a thermoplastic resin as a main component and an emulsion or a dispersion, and in which a melt viscosity of a solid content of the sizing agent at 150° C. and at a shear rate of 10 s⁻¹ is 50 to 300 Pa·s; and a method for producing the fiber reinforcing bundle. Preferably, the sizing agent contains a water-soluble polymer, the sizing agent contains a hardly water-soluble polymer, and the reinforcing fiber bundle is a carbon fiber bundle.

### TECHNICAL FIELD

The present invention relates to a reinforcing fiber bundle, and more precisely, to a reinforcing fiber bundle most suitable for a composite material containing fibers and a matrix resin, and to a method for producing the reinforcing fiber bundle.

### BACKGROUND ART

A composite material where the matrix resin has been reinforced by fibers is lightweight and is also excellent in strength, stiffness, dimensional stability and the like, and is therefore widely developed in general industrial fields including office equipment applications, automobile applications, computer applications (IC trays, housings for notebook-side personal computers, etc.) and the like, and the demand for the material is increasing year by year. However, reinforcing fibers for use for the composite material differ from the matrix resin in the chemical composition and the molecular structure therebetween, and therefore have a serious problem in point of improving affinity and adhesiveness.

In the case where reinforcing fibers are used in the form of fiber bundles in the matrix resin, there further occur various problems in addition to the problem of interface such as affinity and adhesiveness between the fibers and the matrix resin. For example, there is a problem of stability in the step cutting or opening fiber bundles, and a problem of processability in the step of impregnating in the matrix resin. When the condition of fiber bundles could not be stable, the degree of impregnation may greatly differ in the step of impregnating the inner layer part of the fibers with a high-viscosity resin, and therefore the resultant composite material could not have stable physical properties.

Heretofore, for the purpose of enhancing the affinity between a fiber bundle and a matrix resin, various sizing agents have been investigated. For example, Patent Document 1 discloses a method of improving the strength of a composite material by making an epoxy emulsion-type sizing agent adhere to a fiber bundle to thereby improve the interface adhesiveness between the fiber bundle and the matrix resin. Patent Document 2 discloses a method for treatment with an acid-modified polyolefinic sizing agent for a thermoplastic resin polypropylene serving as a matrix.

However, these methods could improve the interface adhesion strength but often harden the texture of fiber bundles and therefore have problems in that the methods significantly worsen handleability and processability. Further, the physical properties of the composite materials to be obtained finally are insufficient. This is because the reinforcing fiber bundles could not be uniformly dispersed in the composite material and could not exhibit a sufficient reinforcing effect.

In particular, in the case where the matrix resin in the composite material is a high-viscosity thermoplastic resin or in the case of a random mat where the reinforcing fiber bundles are further widened, extended, separated and cut, and the resin is randomly applied to the fiber bundles so as to be impregnated thereinto, the problems are serious.

Development of a reinforcing fiber bundle capable of satisfying all the requirements of high processability as well as resin impregnability into the inner layer part of the fiber bundle and adhesiveness between a matrix resin and the fibers and capable of fully improving the physical properties of the composite material has been required.

Patent Document 1: JP-A 4-170435

Patent Document 2: JP-A 2006-124847

### DISCLOSURE OF INVENTION

### Problems to Be Solved by Invention

The present invention addresses the problem of providing a reinforcing fiber bundle that satisfies texture and convergence performance suitable for composite materials such as a random mat and the like and has a high resin impregnation ratio, and a method for producing the reinforcing fiber bundle.

### Means for Solving the Problems

A reinforcing fiber bundle according to an aspect of the present invention is a reinforcing fiber bundle with a sizing agent adhering to the surface thereof, in which the sizing agent contains a thermoplastic resin as a main component and an emulsion or a dispersion, and in which a melt viscosity of a solid content of the sizing agent at 150° C. and at a shear rate of 10 s⁻¹ is 50 to 300 Pa·s.

Further, the melt viscosity of the solid content of the sizing agent at 250° C. is preferably 10 to 200 Pa·s, the sizing agent preferably contains a water-soluble polymer and the sizing agent preferably contains a hardly water-soluble polymer component. Further, also preferably, the solid content of the sizing agent is a mixture of two or more polymer components and contains at least one or more, hardly water-soluble polymer component.

Also preferably, the reinforcing fiber bundle is a carbon fiber bundle.

A method for producing a reinforcing fiber bundle according another aspect of the present invention includes adhering a processing liquid, in which a melt viscosity of a solid content at 150° C. is 50 to 300 Pa·s and which contains an emulsion or a dispersion, to the surface of a fiber bundle constituted by reinforcing fibers, and drying the processing liquid.

A processing liquid for reinforcing fibers is such that a melt viscosity of a solid content thereof at 150° C. is 50 to 300 Pa·s and the liquid contains an emulsion or a dispersion. Alternatively, a processing liquid for reinforcing fibers contains a water-soluble polymer, and an emulsion or a dispersion.

Further, the present invention includes an invention of a composite material that includes reinforcing fibers obtained from these reinforcing fiber bundles and a matrix resin.

### Advantageous Effects of invention

According to the present invention, there are provided a reinforcing fiber bundle that satisfies texture and convergence performance suitable for composite materials such as a random mat and the like and has a high resin impregnation ratio, and a method for producing the reinforcing fiber bundle.

### Embodiments for Carrying Out Invention

A reinforcing fiber bundle according to an aspect of the present invention is a reinforcing fiber bundle with a sizing agent adhering to the surface thereof, in which the sizing agent contains a thermoplastic resin as a main component and an emulsion or a dispersion and in which a melt viscosity of a solid content of the sizing agent at 150° C. and at a shear rate of 10 s⁻¹ is 50 to 300 Pa·s. Further, the melt viscosity of the solid content of the sizing agent at 250° C. and at a shear rate of 50 s⁻¹ is preferably 10 to 200 Pa·s.

When the melt viscosity of the sizing agent at 150° C. and at a shear rate of 10 s⁻¹ is more than 300 Pa·s, the sizing agent may often adhere unevenly. This is because, in general, for removing a solvent such as water or the like from a reinforcing fiber bundle having a sizing processing liquid adhering thereto, the fiber bundle is subjected to drying heat treatment, and in that time, the solid content (polymer) of the sizing agent adhering to the surface of the reinforcing fibers has a high viscosity so that the sizing agent is prevented from uniformly spreading to wet the surfaces of the reinforcing fibers. On the other hand, when the melt viscosity at 150° C. and at a shear rate of 10 s⁻¹ is less than 50 Pa·s, the handleability of the reinforcing fiber bundle worsens. This is because, during the above-mentioned drying heat treatment, the sizing agent can uniformly spread to wet the surfaces of the reinforcing fibers, but the convergence performance of the reinforcing fiber bundle greatly lowers. A more preferred range of the melt viscosity of the sizing agent at 150° C. and at a shear rate of 10 s⁻¹ is 60 to 280 Pa·s, more preferably 70 to 250 Pa·s, most preferably 80 to 200 Pa·s. A more preferred range of the melt viscosity of the sizing agent at 250° C. and at a shear rate of 50 s⁻¹ is 20 to 180 Pa·s, more preferably 30 to 150 Pa·s, most preferably 40 to 140 Pa·s. The melt viscosity of the sizing agent here is a value measured using the extracted solid content thereof as prepared by removing water from the sizing processing liquid.

The wording that the sizing agent contains a thermoplastic resin as the main component means that among the solid content of the sizing agent, the most essential component is a thermoplastic resin. Further, 50% by weight or more, especially 80 to 100% by weight of the solid content of the sizing agent is preferably a thermoplastic resin. The wording that the sizing agent contains an emulsion or dispersion means that components derived from an emulsion or dispersion are contained in the sizing agent adhering to the surfaces of reinforcing fibers. The components may be a pail or all of the thermoplastic resin that is the main component, or may be any other components, but are preferably polymer components.

Fibers that are preferably used for the reinforcing fiber bundle of the present invention include various reinforcing fibers capable of reinforcing the matrix resin. Specifically, preferred examples of such reinforcing fibers include various inorganic fibers such as carbon fibers, glass fibers, ceramic fibers, silicon carbide fibers, etc.; various organic fibers such as aromatic polyamide fibers (aramid fibers), polyethylene fibers, polyethylene terephthalate fibers, polybutylene terephthalate fibers, polyethylene naphthalate fibers, polyarylate fibers, polyacetal fibers, PBO fibers, polyphenylene sulfide fibers, polyketone fibers, etc. Above all, as fibers suitable for the present invention, carbon fibers, glass fibers and aromatic polyamide fibers are preferred, and polyacrylonitrile (PAN)-carbon fibers capable of giving lightweight and high-strength fiber-reinforced composite materials having good specific strength and specific elasticity are especially preferred.

In the present invention, these reinforcing fibers are used as fiber bundles. Regarding the number of the filaments (single fibers) constituting the fiber bundle, 10 fibers or more could be enough, but 100 fibers or more are preferred, and 1000 to 100000 fibers are more preferred. In the case where the reinforcing fiber bundle is a carbon fiber bundle, 3000 to 80000 fibers are preferred from the viewpoint of productivity, and 6000 to 50000 fibers are more preferred. When the number of the filaments constituting the fiber bundle is too small, the flexibility of the fiber bundle could increase to better the handleability thereof, but the productivity of the reinforcing fibers tends to lower. On the other hand, when the number is too large, the productivity of the fiber bundle worsens and, in addition, treatment with a surface-treating agent tends to be difficult. For example, when the reinforcing fibers are carbon fibers and when the number is more than 80000 fibers, it would be difficult to fully complete flame-proofing treatment or infusibilization treatment for carbon fiber precursor fibers, and the mechanical properties of the carbon fibers to be finally obtained may tend to worsen.

The mean diameter of the reinforcing fibers (single fibers) constituting the reinforcing fiber bundle is preferably within a range of 3 to 20 μm. A more preferred range of the mean diameter is 4 to 15 μm, even more preferably 5 to 10 μm. When the mean diameter of the reinforcing fibers is too small, the total number of the fibers to realize the same reinforcing effect must be increased. However, when the number of the fibers is too large, the fiber component is bulky and therefore the volume fraction of the fibers in the composite material is difficult to increase, and the mechanical strength of the resultant composite fiber tends to lower. In particular, when the fibers are inorganic fibers such as carbon fibers, the tendency is remarkable. On the other hand, When the mean diameter of the reinforcing fibers is too large, a sufficient fiber strength tends to be secured. For example, when the reinforcing fibers are carbon fibers and when the mean diameter thereof is more than 20 μm, it would be difficult to fully complete flame-proofing treatment or infusibilization treatment for carbon fiber precursor fibers. In the case, the mechanical properties of the carbon fibers to be finally obtained may tend to worsen.

The entire shape of the fiber bundle is preferably flat (flat fiber bundle). This is because the sizing agent applied into the inside of the fiber bundle can diffuse more easily. Further, in the case of a flat fiber bundle, the matrix resin to be used in producing the final product, composite material can diffuse more readily. The time to be taken before the matrix resin can penetrate into the reinforcing fiber bundle is, in general, proportional to the square of the thickness of the reinforcing fiber bundle (the thinnest part of the diameter of the fiber bundle). Consequently, for finishing impregnation within a short period of time, it is desirable that the reinforcing fiber bundle is extended to thin the thickness of the reinforcing fiber bundle. This is because the impregnation ratio can be increased and the impregnation time can be efficiently shortened.

Specifically, the thickness of the reinforcing fiber bundle is preferably 200 μm or less. However, even when the thickness of the reinforcing fiber bundle is too thin, the bulkiness of the fiber bundle would unnecessarily increase to worsen the handleability and the moldability of the final product. From this viewpoint, the thickness of the reinforcing fiber bundle is preferably 10 μm or more, and even more preferably, the thickness of the reinforcing fiber bundle falls within a range of 30 to 150 μm, especially preferably within a range of 50 to 120 μm.

The width of the reinforcing fiber bundle of the present invention is preferably 5 mm or more, more preferably within a range of 10 to 100 mm. The flatness ratio of the fiber bundle (width/thickness of fiber bundle) is preferably 10 times or more, more preferably within a range of 50 to 400 times. The length of the reinforcing fiber bundle is preferably within a range of 1 to 100 mm, more preferably within a range of 5 to 50 mm. Such a fiber bundle, especially a short fiber bundle having such a high flatness ratio can be readily worked into a random mat, since the fiber bundle of the type can be readily opened in the subsequent step. The composite material that is produced via such a random mat form enjoys a rapid molding speed and is excellent in physical properties, and therefore can be a composite material especially suitable for industrial mass-production.

The reinforcing fiber bundle of the present invention is one produced by making a sizing agent adhere to the surface of the above-mentioned reinforcing fiber bundle. In this, the melt viscosity of the solid content of the sizing agent at 150° C. and at a shear rate of 10 s ⁻¹ is 50 to 300 Pa·s. In addition, it is necessary that the sizing agent contains a thermoplastic resin as the main component and contains an emulsion or a dispersion. Here, the sizing agent contains an emulsion or a dispersion, and preferably, a part of the solid content of the sizing agent is a polymer derived from a forcedly-emulsified or self-emulsified emulsion or dispersion.

Further, it is also preferable that the sizing agent contains particles of an emulsion or dispersion-derived polymer component. The emulsion or dispersion-derived particles are basically such that hardly water-soluble particles are emulsified or dispersed, and the sizing liquid containing the sizing agent of the type is characteristically cloudy or semi-cloudy.

Preferably, the sizing agent contains a water-soluble polymer component (easily water-soluble polymer), or contains a hardly water-soluble polymer component (hardly water-soluble polymer). “Easily water-soluble polymer” as referred to herein indicates a polymer capable of completely dissolving in water to form a transparent aqueous solution; and “hardly water-soluble polymer” indicates a polymer that does not completely dissolve in water but is in a cloudy state in water as an emulsion or a dispersion therein. Here, the easily water-soluble polymer and the hardly water-soluble polymer are components that are included in the thermoplastic resin of the main component.

The thermoplastic resin that is the main component of the sizing agent is not specifically limited, and is preferably a hardly water-soluble polymer alone such as polyester, polyurethane, polyamide or the like, or a mixture thereof. The main component is, as described above, the most constituent component. Further, it is preferable that the solid content of the sizing agent contains a water-soluble polymer as the thermoplastic resin therein.

Also preferably, the sizing agent contains a resin having flexible elasticity such as polyurethane, especially a self-emulsifiable polyurethane resin having a small particle size. Here, the polyurethane is not limited to a thermoplastic one alone but may include any ordinary polyurethane resin, Incorporating a resin having rubber elasticity such as a polyurethane resin or the like can soften the texture of the reinforcing fiber bundle. Further, the resin having rubber elasticity such as a polyurethane resin or the like can exist inside the reinforcing fiber bundle and can therefore effectively solve the problem of folding breakage or frictional fluffing of the reinforcing fiber bundle in winding. Above all, addition of a polyurethane resin in the case where a polyamide resin is the main thermoplastic resin is effective not only in that the sizing agent can wet and spread in the surfaces of the reinforcing fibers but also in that the penetration of the matrix resin into the inner layer part of the reinforcing fiber bundle to be mentioned hereinunder is dominantly attained. This is because, while the characteristics of polyamide having an excellent interface adhesion force can be effectively realized, the viscosity of the sizing liquid can be lowered owing to addition of a polyurethane. In addition, as described above, owing to the excellent flexibility thereof, the polyurethane is, when combined with polyamide, effective in regulating the texture of the reinforcing fiber bundle to a suitable degree while the matrix penetrability and the mechanical properties of the resultant composite material are kept good.

For example, in the case where a hardly water-soluble polymer alone is used as the thermoplastic resin not using a resin having rubber elasticity, and when the fibers are treated for sizing according to a dipping method, the adhesion concentration around the surface of the reinforcing fiber bundle tends to be high. This is because the thermoplastic resin in the form of an emulsion or dispersion that is larger than the diameter of the gap between the fibers constituting the reinforcing fiber bundle firmly adhere to the gap between the fibers. In that condition, the texture of the reinforcing fiber bundle may increase the bundle tends to fluff readily. This is because the bundle is often wound around a winder while a part of the fiber bundle is folded. In addition, the thermoplastic resin could hardly adhere uniformly to the fibers and the fiber bundle may often tend to undergo frictional fluffing.

For solving the problems, it is desirable to control the adhesion amount, and more specifically to control the hardness (texture) of strands by controlling the adhesion amount of the sizing agent.

The solid content of the sizing agent is preferably a mixture of a hardly water-soluble polymer and an easily water-soluble polymer. In the case where the easily water-soluble polymer completely dissolves in water, uniform resin adhesion would be easy even to the inner layer part of the reinforcing fiber bundle. Indeed, the easily water-soluble polymer alone could hardly make the resin penetrate and adhere to the gap between the fibers constituting the reinforcing fiber bundle and therefore the texture of the reinforcing fiber bundle tends to be low. For example, in the case of producing a random mat where the proportion of the fiber bundle and the single fiber is suitably controlled as described below, the random mat tends to be bulky and may have negative influences on resin penetration thereinto. Consequently, it is desirable that an emulsion or dispersion-type, hardly water-soluble polymer is added to the water-soluble polymer, and in the case, it becomes possible to readily obtain a reinforcing fiber bundle having a suitable degree of texture. Regarding the abundance ratio in this case, the polymerization compounding ratio of the water-soluble polymer to the emulsion or dispersion-derived, hardly water-soluble polymer is preferably 1/9 to 9/1. More preferably, the ratio (water-soluble polymer/hardly water-soluble polymer) is within a range of 4/6 to 9/1, even more preferably 7/3 to 9/1.

Examples of the hardly water-soluble polymer include polyesters of polyethylene terephthalate (PET), polybutylene terephthalate (PBT), polytrimethylene terephthalate (PTT), polyethylene naphthalate (PEN), liquid-crystal polyester, block or random copolymers of these polyesters, etc.; polyolefins of polyethylene (PE), polypropylene (PP), polybutylene, acid-modified derivatives of these polyolefins, etc.; styrenic resins, as well as polyoxymethylene (POM), polyamide (PA), copolyamide, polycarbonate (PC), polymethyl methacrylate (PMMA), polyvinyl chloride (PVC), polyphenylene sulfide (PPS), polyphenylene ether (PPE), polyimide (PI), polyamideimide (PAI), polyether imide (PEI), polysulfone (PSU), polyether sulfone, polyketone (PK), polyether ketone (PEK), polyether ether ketone (PEEK), polyarylate (PAR), polyether nitrile (PEN), phenol (novolak or the like) phenoxy resin, fluororesin, polyester polyurethane, polyether polyurethane; and further thermoplastic elastomers such as polystyrene-type, polyolefin-type, polyurethane-type, saturated polyester-type, polyamide-type, polybutadiene-type, polyisoprene-type, fluorine-containing or the like ones; and copolymers and modified derivatives thereof, and resins prepared by blending two or more of these. Further, the above-mentioned, hardly water-soluble polymer is preferably a self-emulsifiable polymer with a hydrophilic group added to the molecular terminal thereof.

Preferably, the hardly water-soluble polymer to be contained in the sizing agent is used in the processing liquid as an emulsion or a dispersion thereof.

Preferred examples of the water-soluble polymer that may be used concurrently include polymers polymerized with a hydrophilic monomer such as polyvinyl alcohol, polyethylene glycol or the like, amine adducts that are reaction products of an epoxy compound and an amine compound and have an alicyclic hydrocarbon structure in the molecular skeleton, amine adduct salts prepared by neutralizing the amine adduct with carbonic acid, acetic acid or the like, etc.

A mixture of the water-soluble polymer and a hardly water-soluble polymer that is in the form of an emulsion or a dispersion may be used in the processing liquid.

As another combination, it is desirable to combine a hardly water-soluble polymer with two types of emulsion of a forcedly-emulsified emulsion and a self-emulsified emulsion. The particle size of the resin that constitutes the forcedly-emulsified emulsion is generally larger than that of the self-emulsified emulsion. With the forcedly-emulsified emulsion, therefore, it is difficult to make the resin therein uniformly adhere to the inner layer part of the reinforcing fiber bundle. However, when a self-emulsified emulsion is added to the forcedly-emulsified emulsion, the resin component in the self-emulsified emulsion having a small particle diameter can penetrate into the inner layer part of the reinforcing fiber bundle, and therefore relatively uniform resin adhesion can be realized. In addition, since the resin uniformly adheres, dry reinforcing fibers are lost and the combination is therefore effective for significantly preventing fluffing in the processing step. The blending ratio of the self-emulsified emulsion-derived, hardly water-soluble polymer to the forcedly-emulsified emulsion-derived, hardly water-soluble polymer is preferably 10/90 to 90/10. More preferably, the ratio (self-emulsified polymer/forcedly-emulsified polymer) is within a range of 60/40 to 10/90, even more preferably 50/50 to 15/85. More specifically, a polyurethane resin or a polyester resin is preferred for the self-emulsified emulsion; and a polyamide resin is preferred for the forcedly-emulsified emulsion to be combined with the former. In particular, a combination of a polyamide resin and a polyurethane resin is preferred in that the matrix penetrability is excellent and the mechanical properties of the resultant composite material are also excellent and that the reinforcing fiber bundle can make have texture suitable for production of random mats to be described below.

As the hardly water-soluble polymer, a combination of two types of forcedly-emulsified emulsions may also be used. In particular, a combination of a forcedly-emulsified polyamide resin and a forcedly-emulsified polyurethane resin realizes excellent matrix penetrability and excellent mechanical properties of the resultant composite material. The ratio of polyurethane to polyamide is preferably within a range of 50/50 to 10/90, more preferably 40/60 to 15/85. This is because, when the blending ratio by weight of polyamide is less than 50, heat resistance may lower, but when the blending ratio by weight of polyamide is more than 90, fluffing in the processing step greatly increases.

Further, when a high-viscosity thermoplastic resin is used as the matrix resin to be combined with the reinforcing fiber bundle of the present invention in the composite material, it is desirable to use a sizing agent having a high surface energy level. This is for the purpose of spreading the matrix resin on the surface of the reinforcing fiber bundle to wet it. From this viewpoint, it is desirable that the sizing agent has at least one bond selected from an amide bond, a urethane bond and an ester bond in the repeating unit in the molecular skeleton thereof. Further, it is more desirable that the sizing agent has at least two or more bonds selected from an amide bond, a urethane bond and an ester bond in the repeating unit.

The sizing agent for use in the present invention must contain an emulsion or the like, in which a hardly water-soluble polymer or an easily water-soluble polymer is mainly used. Especially preferred examples of the hardly water-soluble polymer include various polyester resins, various polyamide resins such as binary, ternary or the like copolyamides, acrylic acid-modified polyamides, etc., various polyurethane resins such as polyester polyurethanes, polyether polyurethanes, etc. As the water-soluble polymer, a reaction product of an epoxy compound and an amine compound is preferred, and use of an amine adduct having an alicyclic hydrocarbon structure in the molecular skeleton thereof, and an amine adduct salt prepared by neutralizing such an amine adduct with carbonic acid, acetic acid or the like is more preferred.

Preferred examples of the hardly water-soluble polyamide resin include 6-nylon, 66-nylon, 610-nylon, 11-nylon, 12-nylon, 6/66 copolymer nylon, 6/610 copolymer nylon, 6/11 copolymer nylon, 6/12 copolymer nylon. etc.

More preferred examples of the copolyamide include copolyamides constituted by various monomers of 6-nylon, 11-nylon, 12-nylon, 66-nylon, etc. Further, mixtures of two or more kinds of these components are also employable.

Further, those prepared by copolymerizing 6-nylon and 66-nylon in an amount of 30% by weight or more of the total weight thereof as the repeating unit therein. Those prepared by copolymerizing the units in an amount of 40 to 80% by weight are more preferred. Within the range, the surface free energy of the sizing agent can be increased and even a matrix resin having a large surface tension such as nylon 6 can be spread to wet fibers. However, when the proportion of 6-nylon and 66-nylon is increased, the melting point of the resin rises. Consequently, the sizing agent itself adhering to the surface of reinforcing fibers may melt and soften and therefore could hardly spread to wet the surfaces of the reinforcing fibers. in the case where a sizing agent where the proportion of 6-nylon and 66-nylon is increased is used, it is desirable that the molecular weight thereof is reduced to lower the crystalline melting point.

The sizing agent adhering to the surface of the reinforcing fiber bundle of the present invention preferably contains a surfactant. The surfactant is preferably a nonionic surfactant or an anionic surfactant capable of emulsifying a hardly water-soluble polymer. Especially, a nonionic surfactant is preferred, and further, a nonionic surfactant having a low molecular weight is more preferred. Specific examples thereof include polyoxyalkylene alkyl ethers. Surfactants having a boiling point of lower than 200° C., more preferably lower than 150° C. are preferred. On the other hand, use of a self-emulsifiable polymer prepared by introducing a hydrophilic group into the molecular terminal of a hardly water-soluble polymer is also preferred.

Also, the sizing agent to be made to adhere to the surface of the reinforcing fiber bundle of the present invention is preferably such that the 5% weight loss temperature in air thereof is 270° C. or higher. This is because, in producing a composite material, the matrix resin (thermoplastic resin) is heated up to around 270° C. to lower the viscosity thereof. When the 5% weight loss temperature in air of the sizing agent is lower than 270° C., the physical properties of the composite material may worsen. This is because, in the process of producing the composite material, a decomposition gas may be generated to form voids in the matrix resin. On the other hand, a sizing agent whose 5% weight loss temperature is merely high may often contain a three-dimensionally crosslinked part, and such a sizing agent tends to hardly adhere to the surface of fiber bundles. A more preferred range of the 5% weight loss temperature in air of the sizing agent is 280 to 350° C. especially 330° C. or lower. The heat resistance of the sizing agent is greatly influenced by the structure of the molecular skeleton of the polymer contained therein. For example, in the case of an amine adduct, it is possible to obtain a sizing agent having high heat resistance by optimizing the structures of the epoxy resin and the amine compound to be the basic ingredients. For example, when a difunctional low-molecular alicyclic epoxy compound is reacted with an amine compound having a saturated alicyclic hydrocarbon structure of with a mixture of an amine compound having a saturated alicyclic hydrocarbon structure and an amine compound having an aliphatic structure, a linear water-soluble polymer especially suitable for use in the present invention as the weight loss in heating thereof is small can be obtained. The sizing agent to adhere to the surface of the carbon fiber bundle of the present invention preferably contains a polymer having such high heat resistance.

In general, for impregnating a high-viscosity matrix resin such as a thermoplastic resin into a reinforcing fiber bundle, the viscosity of the resin must be lowered, and impregnation treatment is carried out at a high temperature. Accordingly, the sizing agent to be used for the reinforcing fiber bundle must have high heat resistance enough to endure impregnation treatment with a matrix resin, and a high-molecular weight thermoplastic resin is often used, in addition, it is known that a high-molecular weight thermoplastic resin can be suitably entangled with the molecular chain of a matrix resin and can therefore increase the interface adhesion force between reinforcing fibers and a matrix resin. However, such a high-molecular weight sizing agent has a high viscosity and is therefore problematic in that it may too strongly converge reinforcing fibers in processing them and therefore may lose flowability. In particular, in producing a composite material via a random mat that is produced by suitably controlling reinforcing fiber bundles and single yarns as described below, this problem is serious. Since reinforcing fiber bundles could not be broken and separated in processing them, it was impossible to increase the resin impregnability in the thickness direction of reinforcing fiber bundles.

However, the sizing agent adhering to the surface of the reinforcing fiber bundle of the present invention has a melt viscosity at 150° C. and at a shear rate of 10 s⁻¹ is 300 Pa·s or less. In the case where the reinforcing fiber matrix with the sizing agent adhering thereto and a matrix resin are heated and pressurized to produce a composite material, the penetrability of the matrix resin into the inner layer part of the reinforcing fiber matrix is extremely bettered. The penetrability of the matrix resin can be significantly increased. Though not clear, the reason would be because the sizing agent whose melt viscosity at 150° C. and at a shear rate of 10 s⁻¹ is 300 Pa·s or less could have a low viscosity at the molding temperature of the composite material and therefore could greatly lower the convergence property of the fiber bundle. Consequently, in the molding process of producing a composite material that includes heating and pressuring of a matrix resin, the fiber bundles could readily be broken owing to the shear stress in flowing of the matrix resin, and the matrix resin could be in a state of readily penetrating into the thickness direction of the fiber bundles. The low-viscosity sizing agent adhering to the reinforcing fiber bundle may act as a plasticizer for the matrix resin to exhibit an effect of accelerating the resin penetration.

On the other hand, when the melt viscosity at 150° C. and at a shear rate of 10 s⁻¹ is more than 300 Pa·s, resin penetration into the inner layer part of the fiber bundle could hardly go on. This is because, since the resin viscosity is high, the convergence of the fiber bundle is strong, and therefore the fiber bundle could not be opened by the shear stress in flowing of the matrix resin. For securing better penetrability of the matrix resin into the inner layer of the reinforcing fiber bundle, the melt viscosity

at 150° C. and at a shear rate of 10 s⁻¹ of the solid content of the sizing agent adhering to the surface of the reinforcing fiber bundle is preferably 60 to 280 Pa·s, more preferably 70 to 250 Pa·s. A more preferred range of the melt viscosity at 250° C. and at a shear rate of 50 s⁻¹ is 20 to 180 Pa·s, even more preferably 30 to 150 Pa·s, most preferably 40 to 140 Pa·s.

As the solid content to constitute the sizing agent, a combination of a water-soluble polymer and a hardly water-soluble polymer is preferred. More specifically, it is desirable that the solid content contains emulsion particles of a water-soluble polymer and a hardly water-soluble polymer. As the hardly water-soluble polymer, a polyamide resin, especially a binary or ternary copolyamide resin, or a polyester resin or a polyurethane resin is preferred.

The water-soluble polymer preferably contained in the sizing agent includes polyvinyl alcohol, polyethylene glycol and amine adduct.

Further, the sizing agent preferably contains a polyester and a polyurethane along with the above-mentioned water-soluble polymer. Further, the polyester and polyurethane to be contained in the sizing agent are polymers derived from emulsion or dispersion. In particular, a self-emulsifiable emulsion is preferred.

The sizing agent for use in the present invention preferably contains an amine adduct, which is used as one component of an adhesive promoter. The amine adduct is preferably a water-soluble polymer. The amine adduct is a reaction product of an epoxy compound and an amine compound, but is preferably a linear thermoplastic resin, not a so-called thermosetting three-dimensional network structure. The amine adduct preferably uses an alicyclic epoxy resin as the starting material. This is because, owing to steric hindrance, the resin is poorly reactive and hardly forms a three-dimensional network structure. Rather than a low-molecular weight compound such as monomer or oligomer, a polymer is preferred. For example, a polymer, in which the number of units of the epoxy compound and the amine compound is 10 or more, is preferred. Also preferably, the amine adduct has an alicyclic hydrocarbon structure in the molecular skeleton thereof. Using the amine of the type for surface treatment for reinforcing fibers, especially those having a form of fiber bundles, secures high opening performance of the fiber bundles. Further, in the case where such reinforcing fibers are used in a composite material, both high adhesiveness and penetrability of the matrix resin can be satisfied.

Also preferably, the sizing agent for use in the present invention contains a hardly water-soluble polymer component along with the water-soluble polymer component, etc. The hardly water-soluble polymer that may be contained in the sizing agent is preferably in the form of an emulsion or a dispersion. Also preferably, the hardly water-soluble polymer is a polyester resin, a polyamide resin or a polyurethane resin.

Though containing a thermoplastic resin as the main component, as mentioned above, the sizing agent for use in the present invention has a low melt viscosity as the sizing agent to exist on the surfaces of reinforcing fibers. Using the sizing agent for surface treatment for reinforcing fiber bundles, the fiber bundle of the present invention secures high opening performance and good processability. Further, in the case where such reinforcing fibers are used in a composite material, both high adhesiveness and penetrability of the matrix resin can be satisfied. The sizing agent for use in the present invention is especially suitable for the present invention as the sizing agent for a fiber-reinforced composite material formed of reinforcing fibers and a matrix resin.

Preferably, the surface tension at 250° C. of the solid component contained in the sizing agent is 25 mN/m or more. By making the polymer have a surface tension of 25 mN/m or more when heated, the physical properties of the composite material can be kept better. In particular, the surface tension at 250° C. is preferably within a range of 27 to 40 mN/m. In the case where the polymer adhering to the surfaces of reinforcing fiber bundles have such an extremely large surface tension as mentioned above, it is desirable that the surface free energy of the reinforcing fiber bundles to be used is previously increased further. In that manner, the polymer does not aggregate on the fiber surfaces but can readily spread and wet the fibers.

The large surface tension of the solid component for use in the present invention is owing to the functional group derived from, for example, the polarity term and the hydrogen bond term contained in the molecular structure thereof. Accordingly, in the case where the solid component has such a high surface tension, it can extremely firmly adhere to the reinforcing fibers used. The component has an effect of strongly bonding filaments (single fibers) constituting the reinforcing fiber bundles to each other and therefore further increasing the convergence power of the reinforcing fiber bundles.

The reinforcing fiber bundles of the type can be reinforcing fiber bundles that are suitable for production of a random mat to be mentioned hereinunder. The convergence power of the reinforcing fiber bundles is preferably within a range of 1 cN or more and less than 6 cN. Reducing the convergence power of the reinforcing fiber bundles makes it possible to soften the texture of the reinforcing fiber bundles, makes it possible to prevent a part of the reinforcing fiber bundles from being folded during winding them with a winder and makes it possible to prevent fluffing and scattering. However, when the convergence power is too small, single fibers may tend to form in production of a random mat to be mentioned below, which may be therefore bulky, and if so, a matrix resin could hardly penetrate thereinto. On the other hand, when the convergence power is too large, the texture of the reinforcing fiber bundle would be high, and when wound with a winder, a part of the reinforcing fiber bundle would be often folded. A preferred range of the convergence power is 2 cN or more and less than 5 cN. A preferred range of the texture is 10 to 180 g, more preferably 20 g or more and less than 140 g.

Here, the surface tension is a parameter that depends on intermolecular force, and is a value to determine the intramolecular cohesion by the polarity term and the hydrogen bond term in the molecule. By substituting the carbon element in the molecular skeleton of the sizing agent with an oxygen element or a nitrogen element, the surface tension can be enlarged.

The heat treatment step of removing the solvent and the like from the processing solution applied onto the surfaces of the reinforcing fibers is at a temperature of at most 250° C., or so, and by defining the physical properties of the fibers at that temperature, more suitable fiber bundles can be obtained. A more preferred range of the surface tension of the sizing agent at 250° C. is 29 to 35 mN/m.

Now, the amine adduct that may be used in the present invention is described in detail. The amine adduct is a reaction product of an epoxy compound and an amine compound. Regarding the constitutional ratio (molar ratio) of the epoxy compound to the amine compound, it is desirable that the amine compound is somewhat excessive, and more specifically, the ratio preferably falls within a range of 1/1.01 to 1/1.1. Here, when one of the epoxy compound or the amine compound is too excessive, it is unfavorable since a polymer could not be formed and a monomer or an oligomer is formed. More basically, a thermoplastic resin compound in which the epoxy compound-derived epoxy group is blocked is preferred. Some but a few unreacted epoxy groups may remain, but when too many remain, the molecular weight tends to lower and the adhesiveness tends to lower. In the process of producing reinforcing fibers, the unreacted epoxy groups having remained slightly may form a three-dimensional network structure, therefore tending to interfere with the adhesiveness to the reinforcing fibers. If so, the physical properties of the composite material to be obtained finally would worsen.

As the epoxy compound of the constituent component, a substance for use in ordinary epoxy resins can be used. For obtaining a linear polymer that is a more preferred embodiment, an epoxy compound having plural, preferably two epoxy groups is preferred. Also preferably, the compound has an alicyclic epoxy group. Such an alicyclic epoxy compound of an olefin oxidized (alicyclic) type one readily undergoes steric hindrance and has poor reactivity, therefore hardly forming a three-dimensional network structure. For example, in the case where the alicyclic epoxy resin of the type is used and thermally reacted with an amine compound or the like to be mentioned next, a linear polymer can be readily formed.

Above all, in consideration of high reactivity, the epoxy compound preferably has an ester bond in the molecule, and is especially preferably an epoxy compound having an ester bond between two alicyclic epoxy groups therein. For example, as the epoxy compound for use in the present invention, 3′,4′-epoxycyclohexylmethyl 3,4-epoxycyclohexanecarboxylate (manufactured by Daicel Corporation, Celloxide “CEL-2021P”, molecular weight 252.3) is preferred.

As the amine compound, a difunctional or more polyfunctional amine compound is preferred. In particular, a difunctional amine compound capable of producing a linear polymer is preferred. Preferably, the amine compound for use herein does not include an amine compound having an aromatic structure. This is because an aromatic structure tends to interfere with adhesiveness to the matrix resin in the final product, composite material. However, an amine compound having an aromatic structure, concretely diaminodiphenyl sulfone, diaminodiphenylmethane or the like may be partly used.

It is also preferable that the above-mentioned epoxy compound and amine compound are used as an amine adduct, after reacted. Also preferably, the molecular skeleton of the polymer has an alicyclic hydrocarbon structure, and further preferably, the epoxy compound has an alicyclic epoxy group. Above all, a reaction product of an alicyclic epoxy compound and an aliphatic amine compound is preferred. Also preferably, the amine compound has an alicyclic structure. In particular, as the amine compound, use of a mixture of an amine compound having a saturated alicyclic hydrocarbon structure and an amine compound having a linear aliphatic structure is preferred, and as the polymer, a reaction product produced by reacting such an aliphatic amine compound and an alicyclic epoxy resin is preferably used. Using the compound facilitates production of a linear polymer having good heat resistance.

Also preferably, in the present invention, the polymer has an ester bond or an ether bond, especially an ester bond, as capable of improving the adhesiveness of processed fibers with the matrix resin. Also preferably, by controlling the side chain or the molecular structure or by devising the dissolution method, a water-soluble polymer is produced.

Preferably, the 5% weight loss temperature in air of the solid content in the sizing agent for use in the present invention is 250° C. or higher, more preferably 280° C. or higher. For example, when a difunctional low-molecular alicyclic epoxy compound is reacted with a mixture of an amine compound having a saturated alicyclic hydrocarbon structure and an amine compound having an aliphatic structure, a linear polymer suitable for the present invention, whose weight loss in heating is small, can be obtained. When the 5% weight loss temperature is too low, and especially when the matrix resin is processed for impregnation at a high temperature, voids may form during the impregnation step, thereby tending to worsen the physical properties of composite materials. On the other hand, a reaction product with a polymer whose 5% weight loss temperature is high may contain many three-dimensionally crosslinked parts, therefore tending to gel with ease. Such a polymer tends to hardly adhere to the surfaces of fiber bundles. The 5% weight loss temperature in air is preferably 330° C. or lower.

In particular, in the case where the reinforcing fiber bundle of the present invention that has, adhering thereto, the sizing agent having specific physical properties is produced, reinforcing fiber bundles most suitable for production of a random mat where short fiber bundles are randomly oriented can be obtained. This is because reinforcing fiber bundles satisfying both suitable draping performance (texture) and convergence power can be readily produced. Though not clear, the reason would be because the hardly water-soluble polymer and the water-soluble polymer could produce a suitably balanced texture. In particular, it is desirable that the random mat using the fiber reinforcing bundles contains incompletely opened, reinforcing fiber bundles of specific number of reinforcing fibers aggregating together and sufficiently opened, reinforcing fiber bundles in a specific ratio. For forming this configuration, it is important to control both the draping performance and the convergence power of the reinforcing fiber bundles.

Specifically, it is desirable that the reinforcing fiber bundles of the present invention are suitably flexible, concretely, the draping degree (texture degree) of the reinforcing fiber bundles of the present invention is preferably within a range of 10 to 180 g. A more preferred range of the draping degree of the reinforcing fiber bundles is 15 g or more and less than 140 g. Falling within the range, the windability of the fiber bundles with a winder and the opening performance thereof could better. In particular, in the case where the reinforcing fiber bundles of the present invention are used in production of a random mat to be mentioned hereinunder and where the draping performance (texture) thereof is controlled to fall within the range, the opened reinforcing fibers could hardly form fluff balls even when diffused by air blowing or the like. A most suitable random mat where reinforcing fiber bundles are in-plane oriented in random directions can be favorably produced.

The draping degree (flexibility) of the reinforcing fiber bundles of the present invention can be evaluated by measuring the resisting force (g), or so-called texture that may develop when a test piece of the reinforcing fiber bundles are put on a test stand with a slit groove formed therein, and the test piece is pushed into a given depth (8 mm) of the groove with a blade, using Handle-O-Meter (HOM-200 manufactured by DAIEI KAGAKU SEMI MFG. Co., Ltd.). When the draping degree of the reinforcing fiber bundles is too high, the windability of the reinforcing fiber bundles with a winder and the opening performance of the reinforcing fiber bundles tend to worsen. On the other hand, when too small, the convergence performance of the reinforcing fiber bundles tends to lower. For securing such the draping degree and especially when fiber bundles of rigid fibers such as carbon fibers or the like are used, it is desirable that the fiber bundle has a flattened shape as mentioned above.

The draping degree of the reinforcing fiber bundle may be correlated with the total filament number of the reinforcing fiber bundle, and the draping degree of the reinforcing fiber bundle is more preferably within a range of 10 to 180 g when the total filament number is 3000 to 50000. The draping degree of the reinforcing fiber bundles can also be controlled by controlling the flattened degree of the fiber bundles and controlling the amount of the reagent such as a surfactant or the like to be used, in addition to the total filament number.

Also, the reinforcing fiber bundles of the present invention preferably have a suitable convergence power. For a random mat using the reinforcing fiber bundles of the present invention, sufficiently opened, single fiber-like fiber bundles can also be used. However, from the viewpoint of moldability, it is desirable that the random mat contains incompletely opened, reinforcing fiber bundles of specific number of reinforcing fibers existing therein and sufficiently opened, reinforcing fiber bundles in a specific ratio. For forming this configuration, it is important to control the convergence performance of the reinforcing fiber bundles. When the convergence power is too high or too low, it is difficult to produce a most suitable random mat of the present invention. Here, the convergence power is a power of converging the reinforcing fibers that constitute the reinforcing fiber bundles sized with a sizing agent. For example, the power can be evaluated by measuring the maximum strength when a reinforcing fiber bundle having a total filament number of 3000 to 50000 and having a width of 0.7 to 1.5 cm is cut into a piece of 1 cm and the resultant reinforcing fiber bundle piece is pulled in the direction vertical to the fiber axis direction. A preferred range of the convergence power is 1 to 6 cN, more preferably 2 cN or more and less than 5 cN. Such convergence power can be expressed by bonding the filaments constituting the reinforcing fiber bundle with a sizing agent.

Regarding the preferred range of the texture and the convergence power of the reinforcing fiber bundle, the texture preferably falls within a range of 1 to 6 cN, and the convergence power preferably falls within a range of 10 to 180 g. In particular, it is desirable that the texture falls within a range of 20 g or more and less than 140 g and the convergence power falls within a range of 2 cN or more and less than 5 cN.

As a result of assiduous studies, the present inventors have found that, in the case where the reinforcing fibers are carbon fibers, a most suitable convergence power can be expressed in production of the random mat of the present invention when the surface free energy of the carbon fibers is 35 mN/m or more and the surface free energy at 250° C. of the sizing agent is 25 mN/m or more. In that manner, by employing a sizing agent whose surface free energy at 250° C. is 25 mN/m or more and whose 5% weight loss temperature in air is 270° C. or higher, a reinforcing fiber bundle having both suitable draping performance (texture) and heat resistance can be obtained.

For the fiber bundles of the present invention, by employing the above-mentioned sizing agent, it has become possible to further increase the high-order processability of the reinforcing fiber bundles to be obtained finally. It is desirable that the hardly water-soluble polymer preferably used in the present invention is used in the sizing processing liquid in an emulsion or dispersion form. In the case, many hardly water-soluble polymer particles larger than the distance diameter between the fiber and the fiber constituting the reinforcing fiber bundle could exist in the fiber-fiber spaces. Though the bonding condition of the reinforcing fiber bundles may tend to differ between the surface layer part and the inner layer part, the hardly water-soluble polymer plays a role of increasing the convergence performance of the reinforcing fiber bundles and securing the good process handleability thereof.

On the other hand, a water-soluble polymer dissolved in water is also favorably used in the sizing processing liquid. Differing from hardly water-soluble polymers, the water-soluble polymer can uniformly adhere to the reinforcing fiber bundle. Further, for securing the convergence performance of the reinforcing fiber bundles, a water-soluble polymer is used along with a hardly water-soluble polymer, and it has become possible to satisfy both good process handleability (convergence performance of reinforcing fibers) and homogeneous sizing agent adhesion.

In the case where the water-soluble polymer dissolves in water, the polymer has many polar groups such as a hydroxyl group, a carboxyl group and the like in the molecular structure. Of the reinforcing fiber bundle obtained by sizing treatment with such a water-soluble polymer, the surface adheres to a metal surface of a roller or the like by a polar force or a hydrogen bond force, therefore tending to enlarge the take-up frictional resistance for the reinforcing fiber bundle. In the case where a water-soluble polymer alone is used, the polymer may readily spread to wet the metal surface of a roller or the like, therefore tending to enlarge the take-up frictional force. However, when a hardly water-soluble polymer is mixed as a part of the sizing agent, surprisingly the take-up frictional force of the reinforcing fiber bundle can be rapidly reduced. With that, scum formation in the process can be greatly inhibited. Though not clear, the reason would be because the hardly water-soluble polymer could dilute the number of the polar groups in the solid content of the processing liquid and could increase the viscosity of the solid content, therefore preventing the sizing agent from spreading and extending over the metal surface.

In the case where a hardly water-soluble polymer alone is used in the sizing agent, the adhesion amount thereof is, for the purpose of securing the sizing agent adhesion that is as homogeneous as possible and securing suitable convergence and texture of strands, preferably 0.1 to 1.0 part by weight relative to 100 parts by weight of the reinforcing fiber weight, more preferably 0.2 to 0.7 parts by weight. Controlling the sizing agent adhesion to fall within the range makes it possible to produce a reinforcing fiber bundle that satisfies both suitable convergence and suitable texture and is excellent in processability to give a random mat to be mentioned hereinunder. On the other hand, in the case of a sizing treatment agent that contains both a hardly water-soluble polymer and a water-soluble polymer, the water-soluble polymer contributes little toward increasing the convergence, and therefore the adhesion amount thereof tends to increase for obtaining suitable convergence and texture excellent in processability to give a random mat. A preferred range of the adhesion amount is, depending on the blend ratio of the hardly water-soluble polymer and the water-soluble polymer, 0.4 to 2.0 parts by weight relative to 100 parts by weight of the reinforcing fiber weight, more preferably 0.7 to 1.5 parts by weight.

The fiber bundle of the present invention is effectively processed into a random mat via widening, opening and the like treatment on a metal roll, and in the process, the adhesiveness of the fiber bundle to the metal roll lowers and the processability thereof can therefore noticeably improved. In addition, since the adhesiveness decreases, the fiber bundle can be sufficiently prevented from fluffing and forming scum, and as a result, the physical properties of the final product, composite material formed of the reinforcing fiber bundle and a matrix resin can be improved.

The present invention includes a fiber-processing liquid for use for the reinforcing fiber bundle of the present invention, and a composite material formed of the reinforcing fiber bundle of the present invention and a matrix resin.

In the reinforcing fiber bundle of the present invention as mentioned above, the sizing agent adhering to the surface of the fiber bundle melts and soften by heat, and finally when the reinforcing fiber bundle forms a composite material along with a matrix resin, the reinforcing fiber bundle is broken and separated so that the matrix resin penetrates into the inner layer part of the reinforcing fiber bundle, and the sizing agent adhering to the reinforcing fibers is entangled with the matrix resin on a molecular level to realize firm interface adhesion. To that effect, the composite material using the reinforcing fiber bundle of the present invention can finally have good physical properties.

The reinforcing fiber bundle of the present invention can be produced according to the production method for the reinforcing fiber bundle that is another aspect of the present invention. The production method for the reinforcing fiber bundle of the present invention is described more concretely. The method for producing the reinforcing fiber bundle includes adhering a processing liquid, in which the melt viscosity of the solid content at 150° C. is 50 to 300 Pa·s and which contains an emulsion or a dispersion, to the surface of a fiber bundle constituted by reinforcing fibers, and drying it.

The fiber bundle constituted by reinforcing fibers to be used here may be one for use for the above-mentioned reinforcing fiber bundle of the present invention.

Concretely, the reinforcing fibers include various inorganic fibers and various organic fibers. Above all, carbon fibers, glass fibers and aromatic polyamide fibers are preferred. In particular, polyacrylonitrile (PAN)-carbon fibers capable of giving lightweight and high-strength fiber-reinforced composite materials having good specific strength and specific elasticity are preferred.

Among these, when a high-viscosity thermoplastic resin is used as the matrix for the composite material, it is preferable to use a sizing agent having a high surface free energy in order that the thermoplastic resin can be spread to wet the surface of the reinforcing fiber bundle. From this viewpoint, the sizing agent preferably has at least one or more bonds selected from an amide bond, a urethane bond and an ester bond as the repeating unit in the molecular skeleton thereof. More preferably, the sizing agent has at least two or more bonds selected form an amide bond, a urethane bond and an ester bond in the repeating unit.

Accordingly, the sizing agent for use in the present invention preferably contains, as a hardly water-soluble polymer, any of various polyester resins, various polyamide resins such as binary, ternary or the like copolyamides, acrylic acid-modified polyamides and the like, and various thermoplastic polyurethane resins such as polyester polyurethanes, polyether polyurethanes, polycarbonate polyurethanes, polyether-ether polyurethanes and the like, and, as a water-soluble polymer, any of amine adducts that are reaction products of an epoxy compound and an amine compound and have an alicyclic hydrocarbon structure in the molecular skeleton, amine adduct salts prepared by neutralizing the amine adduct with carbonic acid, acetic acid or the like, etc.

The sizing agent for use in the present invention contains a thermoplastic resin as the main component, and contains an emulsion or a dispersion for securing suitable texture and convergence performance. Accordingly, the sizing agent indispensably contains a hardly water-soluble polymer having a form of an emulsion or dispersion. The sizing agent for use in the present invention may be a mixture of two or more kinds of polymers. In the case where two or more kinds of polymers are used as mixed, hardly water-soluble polymers may be mixed or a hardly water-soluble polymer and a water-soluble polymer may be mixed.

In particular, in the case where a polyamide resin having a high viscosity and a large surface tension is used as the matrix for the composite material, the sizing agent must have a high surface free energy for the purpose of widely wetting the polyamide resin such as nylon 6 or the like. In addition, for securing excellent processability for a random mat to be mentioned below, the reinforcing fiber bundle must satisfy excellent continuous productivity free from frictional fluffing on the surface of the reinforcing fiber bundle, in addition to having suitable convergence performance and texture. From this viewpoint, the sizing agent preferably uses an emulsion or dispersion of a polyamide or a mixture of a polyamide and a polyurethane. Preferred examples of the polyamide include 6-nylon, 66-nylon, 610-nylon, 11-nylon, 12-nylon, 6/66 copolymer nylon, 6/610 copolymer nylon, 6/11 copolymer nylon, 6/12 copolymer nylon, 6/66/12 copolymer nylon, 66/11/12 copolymer nylon, etc. These polymers or copolymers may be used either singly or as a mixture of two or more kinds of them.

On the other hand, the polyurethane for use in the present invention may be obtained according to a known method of, for example, polyaddition reaction of a polyisocyanate and a polyol. The polyurethane for use in the present invention is preferably a thermoplastic resin, but is not limited thereto. Concretely, it may be an aromatic polyurethane resin, a non-aromatic polyurethane resin, or a mixture thereof. The aromatic polyurethane resin is not specifically limited so far as it is a polyurethane resin having an aromatic ring in the monomer unit of the resin, and examples thereof include a polyurethane resin obtained through reaction of a starting material of an aromatic isocyanate such as tolylene diisocyanate or diphenylmethane diisocyanate. Also not specifically limited, the non-aromatic polyurethane resin may be any other polyurethane resin than the above-mentioned aromatic polyurethane resin, and examples thereof include a polyurethane resin obtained through reaction of a starting material of an aliphatic isocyanate or an alicyclic isocyanate such as hexamethylene diisocyanate, dicyclohexylmethane diisocyanate, isophorone diisocyanate or the like. In particular, in a self-emulsified urethane emulsion, the particle size of the emulsion particles is smaller than that in a forcedly-emulsified emulsion, and therefore a self-emulsified urethane emulsion secures good penetration into the inner layer part of reinforcing fiber bundles. Consequently, for realizing homogeneous sizing agent adhesion, a self-emulsified urethane emulsion is preferably used. As the converging agent containing such a polyurethane, for example, those produced according to known methods can be used, and in addition thereto, a trade name Vondic, a trade name Vondic 2200 Series, a trade name Hydran HW Series (Hydran HW-301, Hydran HW-310, Hydran HW-311, Hydran HW-312B, Hydran HW-325, Hydran HW-337, Hydran HW-920, Hydran HW-935, Hydran HW-940, Hydran HW-950), Hydran AP Series, Hydran ADS and a trade name Hydran CP Series all sold by DIC Corporation, and Uprene UX-306, Uprene UX-312, Uprene UA-110, Permarine UA-110 and Permarine UA-200 all manufactured by Sanyo Chemical Industries, Ltd., Resamine D-1005 manufactured by Dainichiseika Color & Chemicals Mfg. Co., Ltd. as well as Dispercole U42, Dispercole U53 and Dispercole U54 all manufactured by Bayer Holding Ltd. and others can be used.

The mixed quantity of the polyamide relative to the total weight of the polyamide and polyurethane in the emulsion or dispersion of a mixture of polyamide and polyurethane preferably falls within a range of 30 to 100% by weight. When the polyamide content is less than 30% by weight, fluffing by abrasion of the reinforcing fiber bundle could be extremely inhibited but the texture of the reinforcing fiber bundle may often lower too much. Consequently, the random mat to be mentioned below may tend to be bulky and impregnation thereof with a matrix resin would be difficult. On the other hand, especially in the case where a polyamide having a small content of a unit having a long aliphatic chain such as nylon 11, nylon 12 or the like in a binary or ternary copolymer nylon is used as the sizing agent, a reinforcing fiber bundle having a large surface free energy capable of widely wetting nylon 6 to be the matrix and having suitable convergence and texture excellent in processability into a random mat can be obtained. However, for further preventing abrasion fluffing in continuous operation, polyurethane is preferably added. Abrasion fluffing not only detracts from the quality of the reinforcing fiber bundle but also causes process trouble, and from the viewpoint of preventing abrasion fluffing, polyurethane is preferably added. A more preferred range of the mixed quantity of polyamide relative to the total weight of polyamide and polyurethane is 50 to 95% by weight, even more preferably 60 to 90% by weight.

In the sizing agent for use in the present invention, the melt viscosity at 150° C. of the solid content is 50 to 300 Pa·s, and in one preferred embodiment of the invention, a reinforcing fiber bundle is immersed in a sizing processing liquid containing an emulsion or a dispersion, and then the solvent such as water or the like is removed. Here, the processing liquid favorably used for reinforcing fibers in the present invention is a processing liquid indispensably containing an emulsion or a dispersion.

In a preferred embodiment of the method of the present invention, hardly water-soluble particles larger than the diameter of the gap between the fiber and the fiber constituting the reinforcing fiber bundle exist. In that, the particles eccentrically exist in the fiber-to-fiber gap to enhance the convergence performance of the reinforcing fiber bundle. As a result, suitable texture and convergence performance of the reinforcing fiber bundle having good process handleability and suitable for random mat production can be secured. On the other hand, in the present invention, use of a water-soluble polymer as mixed in the emulsion or dispersion is also a preferred embodiment, in which the wising agent can be uniformly adhered to the reinforcing fiber bundle. The sizing agent for use in the present invention can satisfy both good process handleability (convergence performance of reinforcing fibers) and suitable texture favorable for homogeneous sizing agent adhesion and random mat production.

According to a production method for the reinforcing fiber bundle in the present invention, the above-mentioned processing liquid is made to adhere to the reinforcing fiber bundle, and then dried. The processing liquid is preferably an aqueous dispersion as mentioned above, and in the drying step, excessive water and solvent are removed from the aqueous dispersion.

As a method for applying the processing liquid, a method of immersing reinforcing fiber bundles in a processing liquid is the most popular method. There is no limitation on the method of removing water and solvent from reinforcing fiber bundles, and in the drying treatment of the present invention, various means of heat treatment, air drying, centrifugation and the like may be combined. From the viewpoint of cost, heat treatment is preferred, and as the heating means for heat treatment, for example, hot air, hot plate, roller, IR heater and the like may be used. The temperature of heat treatment (drying treatment) is preferably so controlled that the surface temperature of the reinforcing fiber bundles could fall within a range of 50 to 250° C. to remove solvent, etc. Also preferably, the heat treatment temperature is stepwise turned up within a range of 50 to 250° C. to enable more uniform drying. Treatment at a high temperature of 100° C. or more may remove various components such as surfactant and the like that may interfere with adhesion between reinforcing fibers and matrix. However, when the treatment temperature is too high, the sizing agent and even the reinforcing fiber bundles may degrade.

In the production method for the reinforcing fiber bundle in the present invention, the processing liquid may be applied under the same condition for ordinary sizing liquids. In this case where only a hardly water-soluble polymer is used in the sizing processing agent, the amount of the processing liquid to adhere to the fibers is, for the purpose of securing sizing agent adhesion as homogeneous as possible and suitable convergence performance and texture of strands, preferably such that the solid adhesion amount thereof is 0.1 to 1.0 part by weight relative to 100 parts by weight of the reinforcing fiber weight, more preferably 0.2 to 0.7 parts by weight. Controlling the sizing agent adhesion to fall within the range makes it possible to provide a reinforcing fiber bundle that satisfies both suitable convergence performance and texture and is excellent in processability into the random mat to be mentioned below. On the other hand, in the case of a sizing treatment agent that contains both a hardly water-soluble polymer and a water-soluble polymer, the adhesion amount thereof is preferably increased for securing texture and excellent and suitable convergence performance. A preferred range of the solid adhesion amount is, depending on the blending ratio of the hardly water-soluble polymer and the water-soluble polymer, 0.4 to 2.0 parts by weight relative to 100 parts by weight of the reinforcing fiber amount, more preferably 0.7 to 1.5 parts by weight.

The solid adhesion amount of the processing liquid as referred to herein is a total of the polymer to remain after removal of solvent from the reinforcing fiber bundles immersed in the processing liquid and all the nonvolatile minor components. The proportion of the polymer in the solid content of the processing liquid is preferably within a range of 10% by weight to 100% by weight, more preferably 50% by weight to 100% by weight. When the adhesion amount of the processing liquid is too small, the interface adhesion between matrix and reinforcing fibers in the final product, composite material, in which a thermoplastic resin (thermoplastic polymer) is a matrix, may lower so that the mechanical properties of the composite material tend to worsen. On the contrary, when the adhesion amount of the processing liquid is too large, the adhesion between matrix and reinforcing fibers may lower owing to precipitation of the surfactant slightly existing in the processing liquid.

In the reinforcing fiber bundle of the present invention, especially in the reinforcing fiber bundle having a large surface free energy, a sizing agent having a relatively large surface tension can be uniformly adhere to the surfaces of the fibers. Accordingly, the reinforcing fiber bundle can be a reinforcing fiber bundle satisfying both draping performance (texture) and convergence performance more suitable for random mat production. In addition, the hardly penetrable bundle form of the reinforcing fiber bundles can be broken and separated in the molding step, therefore facilitating matrix penetration into the thickness direction of the fiber bundles. The sizing agent for use in the present invention has good heat resistance, and therefore generate little decomposition gas in the thermal penetration step in producing composite materials, and therefore composite materials having good mechanical properties can be obtained.

According to the production method for reinforcing fiber bundles of the present invention, the reinforcing fiber bundle of the present invention can be obtained. The reinforcing fiber bundle of the present invention is, when used along with a matrix resin, most suitable for fiber/resin composite materials.

Further, the reinforcing fiber bundle of the present invention is favorable for a random mat where the reinforcing fiber bundles are oriented in random directions.

Further, the random mat in which the reinforcing fiber bundles of the present invention are oriented randomly may be compounded with a matrix resin to give a composite material having excellent strength. These random mat and composite material contain the reinforcing fiber bundles of the present invention, and the matrix resin therein is preferably a thermoplastic polymer.

Here, the random mat is one in which reinforcing fibers are not oriented in a specific direction in the mat plane but are arranged as dispersed in random directions. The mat plane means a plane in width and length directions, and differs from a three-dimensional direction including a thickness direction. In a shaped mat form, in general, fibers having a length in some degree are parallel to the plane and are hardly oriented randomly. In the present invention, it is important that the reinforcing fibers in the mat plane are in random orientation. The random mat may be one including a matrix resin in addition to those formed of reinforcing fibers alone. In the case of the fiber form of the random mat, the fiber bundles are preferably discontinuous fiber bundles having a fiber length of 2 to 100 mm, and the fiber areal weight of the fibers constituting the random mat is preferably 25 to 10000 g/m². More preferably, the fiber bundles are discontinuous fiber bundles having a fiber length of 3 to 60 mm and a fiber areal weight of 25 to 3000 g/m².

For such random orientation of the reinforcing fiber bundles, the reinforcing fiber bundles to be used are preferably ones that have been once opened suitably. The random mat may be formed of reinforcing fiber bundles alone, but may be formed of those prepared by cutting such opened reinforcing fiber bundles into short fibers, and a resin, preferably a thermoplastic resin, in which the reinforcing fibers are substantially randomly oriented in the plane, Reinforcing fibers that have been completely opened into single fibers may also be used, but still in the case, it is desirable that a fiber bundle state could remain in the surfaces of the single fibers.

For opening reinforcing fiber bundles, the reinforcing fiber bundles of the present invention may be processed in a fiber extending and widening treatment step. The fiber extending and widening treatment step is not specifically limited, and preferred examples thereof include a method of drawing fibers with a round bar, a method of using an air jet, a method of vibrating fibers with ultrasonic waves, etc. In this case, the reinforcing fiber bundles are preferably flattened reinforcing fiber bundles as mentioned above. The fiber bundles of the type can be more readily opened. For example, according to a method of opening fiber bundles by air blowing onto reinforcing fiber bundles, the degree of opening can be suitably controlled by the air pressure, etc.

The fiber bundles to he processed in the extending and widening treatment step may be either continuous fiber bundles or discontinuous fiber bundles.

The opening ratio of the reinforcing fiber bundle most suitable for random mat is preferably 40% or more. The opening ratio of the reinforcing fiber bundles may be suitably selected depending on the composite material to he obtained, but is more preferably within a range of 45 to 90%, even more preferably 45 to 80%. The opening ratio of reinforcing fiber bundles as referred to herein is evaluated as follows. A reinforcing fiber bundle is cut into 20 mm length, introduced into a tapered tube in which the diameter of the reinforcing fiber slot is 20 mm, the diameter of the blow-out mouth is 55 mm and the length of the tube from the slot to the blow-out mouth is 400 mm, and compressed air is jetted thereinto so that the compressed air pressure being jetted into the tapered tube could be 0.25 MPa, and after the air blow, the weight ratio of the fiber bundles having a width of less than 0.6 mm existing in the total fibers is measured to evaluate the opening ratio.

The random mat using the reinforcing fiber bundles of the present invention can be produced, for example, according to the specific steps mentioned below.

1. A step of opening and cutting the reinforcing fiber bundles of the invention.

2. A step of introducing the cut reinforcing fiber bundles into a tube and blowing air onto the fibers to open the fiber bundles.

3. A step of spreading the opened reinforcing fibers, and a thermoplastic resin is sprayed thereonto.

4. A step of fixing the coated reinforcing fibers and the thermoplastic resin.

In these steps, in the step 3, a solution-type thermoplastic resin may be applied in addition to simultaneously applying a fibrous, powdery or granular thermoplastic resin, or reinforcing fibers alone may be sprayed and a thermoplastic polymer film having a thickness of 10 μm to 300 μm may be coated thereon. In the case of spraying a thermoplastic resin, it is desirable that opened reinforcing fiber bundles and a thermoplastic resin are simultaneously sucked and sprayed.

The random mat having the reinforcing fiber bundles of the present invention as the constituent element is most suitably used for a reinforcing component for a composite material. It is also preferable to use, together with the random mat, any other various types of reinforcing fibers such as monoaxially-aligned fibers, woven fabrics and the like as other reinforcing components for the composite material.

Preferably, the random mat contains incompletely opened reinforcing fiber bundles, for which the opening degree of the reinforcing fiber bundles is so controlled that a specific number of more reinforcing fibers could exist therein, and sufficiently opened reinforcing fiber bundles in a specific ratio. As the case may be, it is also possible to use reinforcing fibers that have been completely opened into single fibers. In the present invention, by producing a random mat having a suitable opening ratio, the reinforcing fibers and the thermoplastic resin can be more densely adhered together, and the resulting random mat can attain high-level physical properties.

The composite material of another aspect of the present invention contains the reinforcing fibers obtained from the reinforcing fiber bundles of the present invention mentioned above and a matrix resin. Here, the reinforcing fibers obtained from the reinforcing fiber bundles indicate various types of reinforcing fibers obtained through treatment of reinforcing fiber bundles, and include reinforcing fibers that have been completely opened to be single fibers, and strand-type reinforcing fibers that have been incompletely opened. The fibers constituting the composite material may be reinforcing fibers of single fibers alone, or on the contrary, may be constituted by fiber bundle-type reinforcing fibers alone, but in the composite material, it is desirable that bundle-type fibers remain partly.

Further, the composite material is preferably produced via a state of the above-mentioned random mat. The composite material contains reinforcing fibers and a thermoplastic resin fixed therein, and can be readily obtained by thereto-forming at a temperature not lower than the softening point of the thermoplastic resin of the matrix resin. The softening point as referred to herein is a temperature at which the thermoplastic resin can fully flow, and can be measured, for example, using a softening point measuring device. In the case of a crystalline resin, the softening point thereof is higher by a few degrees than the melting point thereof, but in the case of an amorphous resin, the softening point is, though depending on the molecular weight thereof, higher by 10 to 150° C. than the glass transition temperature thereof. The temperature at which reinforcing fibers and a thermoplastic resin are fixed, that is, the molding temperature is more preferably higher by 10 to 70° C. than the softening point.

The content of the reinforcing fibers in the composite material is preferably within a range of 10 to 60% by volume. The composite material containing the reinforcing fiber bundles of the present invention secures sufficient penetration of the matrix resin to be compounded therein, and have high quality with little strength unevenness. The composite material containing such reinforcing fibers may contain various additives within a range not detracting from the advantageous effects of the present invention. The other substances than the reinforcing fibers that are contained in the composite material are other reinforcing single fibers, and one or more thermoplastic resins.

The matrix resin for use in the composite material of the present invention is not limited, hut is preferably a resin of a thermoplastic polymer, and is especially preferably a polyamide resin, a polyester resin, an acid-modified polypropylene resin or a polycarbonate resin. Above all, a polyamide-type, polypropylene-type, polyester-type or polycarbonate-type resin can exhibit, especially when used along with rigid short fibers, in particular with the random mat of the present invention, better physical properties owing to the synergistic effect therewith. Further, in the case where the short fibers are rigid carbon fibers, the effect is remarkable.

Of the matrix resin for use in the composite material of the present invention, the surface free energy at 250° C. is preferably 35 mN/m or less. When the surface free energy of the matrix resin is too large, the matrix resin could not fully spread to wet the surfaces of the reinforcing fibers or the surfaces of the reinforcing fiber bundles coated with a sizing agent, and may tend to melt and aggregate on the surfaces. When the matrix resin melts and aggregates, the interface adhesiveness of the composite material and the physical properties thereof worsen. Further, the surface free energy of the matrix resin is preferably smaller than the surface free energy of the reinforcing fibers and the sizing agent. The molding temperature of the composite material is generally at most 300° C., but on the other hand, the surface free energy of the matrix resin achieves equilibrium at around 250° C. or higher. Specifically, by defining the physical properties of the matrix resin at a temperature of 250° C., a suitable composite material can be obtained. In the composite material of the present invention, the surface free energy at 250° C. of the matrix resin is more preferably within a range of 24 to 34 mN/m, even more preferably within a range of 26 to 33 mN/m. The matrix resin falling within the range is, for example, preferably a polyamide resin.

The surface tension of the sizing agent adhering to the surface of the reinforcing fiber bundle for use in the composite material of the present invention is preferably 25 mN/m or more, as mentioned above. in the composite material of the present invention, the absolute value of the surface free energy difference between the sizing agent component and the matrix resin at the molding temperature is preferably 6 mN/m or less. A more preferred range of the absolute value of the surface free energy difference is 3 mN/m or less, even more preferably 2 mN/m or less.

Further, the surface free energy of the main component of the sizing agent at the molding temperature is preferably larger than the surface free energy of the matrix resin. In this case, the matrix resin in the composite material can spread to wet the surfaces of the reinforcing fibers coated with the sizing agent in a short period of time. Even in the case where the sizing agent reacts with the matrix resin, the surface free energy of the sizing agent component is preferably large than the surface free energy of the matrix resin. In this case, the absolute value of the surface free energy difference between the sizing agent and the matrix resin does not have any significant influence.

In the composite material constituted by the reinforcing fiber bundles of the present invention and a matrix resin may contain, along with the cut short fiber bundles used in the random mat, a monoaxially-aligned component in the form of long fibers. Here, the monoaxially-aligned component is one that can he obtained by arranging monoaxially-aligned reinforcing fiber bundles and then bringing them into contact with a melted and softened thermoplastic resin.

The composite material may contain various additives such as an inorganic filler and the like within a range not detracting from the object of the present invention. The inorganic filler includes various types of inorganic fillers such as talc, calcium silicate, wollastonite, montmorillonite. If desired, other additives that are heretofore incorporated in thermoplastic resin, such as heat-resistant stabilizer, antistatic agent, weather-resistant stabilizer, light-resistant stabilizer, antiaging agent, antioxidant, softener, dispersant, filler, colorant, lubricant, etc., can also be incorporated. Also preferably, various types of reinforcing single fibers and one or more thermoplastic resins may be incorporated as other constituent components than the reinforcing fiber bundles of the present invention,

The composite material can secure high-level physical properties owing to the presence of the sizing agent existing between the fibers and the matrix resin therein. The composite material can be, though lightweight, a composite material excellent in strength characteristics, especially bending characteristics such as bending strength and bending elastic modulus and the like, since the adhesiveness between the reinforcing fibers obtained from the reinforcing fiber bundles of the present invention and the matrix resin therein is high. The composite material of the present invention is most suitably used in various fields of business equipment applications, automobile applications, computer applications (IC trays, housings of notebook-type personal computers, etc.), etc.

### EXAMPLES

Hereinunder the present invention is described in more detail with reference to Examples, but the following Examples are not to restrict the present invention. Examples of the present invention were evaluated according to the methods described below.

(1) Extraction of Solid Content from Sizing Processing Liquid and Emulsion

A sizing processing liquid or an emulsion was dried at 120° C. for 5 hours in a hot air drier to remove water, and then dewatered for 2 hours in a vacuum drier (−0.1 MPa) at the same temperature to thereby extract the solid content from the sizing processing liquid or the emulsion.

(2) Evaluation of Thermal Property

Using a differential scanning calorimeter (DSC) manufactured by Perkin Elmer Co., Ltd., the solid content of the above (1), as extracted from the sizing processing liquid or the emulsion, was heated up to 250° C. at a rate of 5° C./min in a nitrogen atmosphere to measure the crystalline melting point thereof.

(3) Method for Measurement of 5% Weight Loss Temperature

The 5% weight loss temperature of the solid content of the above (1) extracted from a sizing processing liquid or an emulsion was calculated as follows, using a differential thermogravimetric analyzer (TGA) manufactured by Seiko Instruments Inc. 10 mg of a sample was heated up to 400° C. at a rate of 10° C./min in a nitrogen stream of 50 mL/min to draw a weight loss curve, from which the 5% weight loss temperature of the same was calculated.

(4) Measurement of Melt Viscosity

For measurement of the melt viscosity of the solid content of the above (1) extracted from a sizing processing liquid or an emulsion, Capilograph 1D manufactured by Toyo Seiki Seisaku-sho, Ltd. The melt viscosity at 150° C. and at a shear rate of 10 was evaluated, using a capillary having a pore diameter of 1 mm and a length of 10 mm. The melt viscosity at 250° C. and at a shear rate of 50 s⁻¹ was evaluated, using a capillary having a pore diameter of 0.5 mm and a length of 5 mm. The unit is Pa·s.

(5) Evaluation of Softening Point of Polymer

The softening point of each polymer was evaluated at a heating rate of 1° C./min, using a softening point measuring device (FP-90) manufactured by Mettler-Toledo International Inc.

(6) Measurement of Surface Tension of Solid Content Extracted from Sizing Processing Liquid or Emulsion

A suspension drop of the solid content or a matrix resin melted at 250° C. or 260° C. was prepared using an automatic contact angle meter (DM-501) manufactured by Kyowa Interface Science Co., Ltd., and the surface tension thereof was measured according to a suspension drop method. An average of the measured values obtained in three trials of each suspension drop is referred to as the surface tension of the analyzed sample.

(7) Measurement of Surface Tension of Reinforcing Fiber Bundle

An unprocessed reinforcing fiber bundle (unsized reinforcing fiber bundle) was cut into 1 cm pieces, and these were floated in a tall beaker filled with 150 cc of water. With stirring, ethanol was added thereto at a rate of 3 ml/min, and ethanol addition was continued until the reinforcing fibers began to sink. The surface tension of the ethanol aqueous solution at the time when the reinforcing fiber bundle sank was estimated from the surface tension of the ethanol aqueous solution provided by Japan Alcohol Association, and the value is referred to as the surface tension of the reinforcing fiber bundle. The unit is mN/m.

(8) Evaluation of Penetrability of Processing Liquid

A sizing agent-containing processing liquid (aqueous dispersion) was put into a glass container up to a height of 5 cm from the bottom thereof. An unprocessed reinforcing fiber bundle that had been cut in the fiber direction into 1-cm pieces (unsized flattened carbon fiber bundle, manufactured by Toho Tenax Co., Ltd., “Tenax STS-24K N00”, diameter 7 μm×24000 filaments, width 16 mm, thickness 142 μm) was immersed in the liquid, and after the immersion, the wetting condition of the surface of the fiber bundle and the time taken until the fiber bundle sank in the bottom of the glass container were measured to evaluate the penetrability of the processing liquid.

(9) Evaluation of Processing Liquid Adhesion Amount

The solid adhesion amount of the processing liquid was calculated as follows. Two processed reinforcing fiber bundles of 1.0 m (carbon fiber bundles) were sampled, and these were heated up to 550° C. at a rate of 10° C./min in a nitrogen atmosphere, then fired at the same temperature for 10 minutes, and the resultant weight loss was calculated as the solid adhesion amount of the processing liquid, according to the following formula (1).

Solid adhesion amount of processing liquid=(a−b)/b×100[%] (1)

a: reinforced fiber bundle weight before firing treatment [g]
b: reinforced fiber bundle weight after firing treatment [g]

(10) Evaluation of Opening Ratio

The opening ratio of opened reinforcing fiber bundles was evaluated as follows. First, 20 mm of a reinforced fiber bundle was cut into pieces of 20 mm, introduced into a tapered tube, in which the diameter of the reinforcing fiber slot is 20 mm, the diameter of the blow-out mouth is 55 mm and the length of the tube from the slot to the blow-out mouth is 400 mm and in which five holes of φ1 mm each are formed in the tube, and compressed air was jetted thereinto so that the compressed air pressure being jetted into the tapered tube could be 0.25 MPa. By direct compressed air blow to the reinforcing fiber bundle, the fiber bundle was opened, and sprayed onto the table arranged below the tapered tube outlet. After the air blow, the weight ratio of the fiber bundles having a width of less than 0.6 mm existing in the total fibers was measured to evaluate the opening ratio.

(11) Evaluation of Draping Performance (Texture Degree) of Reinforcing Fiber Bundle

The draping performance (texture degree) of reinforcing fiber bundles was evaluated according to JIS L-1096 E Method (Handle-O-Meter Method) using HANDLE-O-Meter (HOM-200 manufactured by DAIEI KAGAKU SEIKI MFG. Co., Ltd.). A reinforcing fiber bundle was opened in such a controlled manner that the length of the test piece thereof for use for draping performance measurement could be 10 cm and the width thereof with 1600 filaments could be 1 mm. The slit width was set to be 10 mm. One reinforcing fiber bundle to be the test piece was put on a test stand with a slit groove formed therein, and pushed into a given depth (8 mm) of the groove with a blade, whereupon the resisting force (g) to develop in pushing the sample was measured. An average of the measured values obtained in three trials is referred to as the texture degree of the reinforcing fiber bundle.

(12) Evaluation of Convergence Power of Reinforcing Fiber Bundle

The convergence power of reinforcing fiber bundles was evaluated as follows. A reinforcing fiber bundle was cut into pieces of 1 cm, and using RTC-1150A manufactured by Orientec Corporation, the piece was pulled in the direction vertical to the fiber axis direction, whereupon the maximum strength in pulling was measured. An average of the measured values obtained in 50 trials is referred to as the convergence power of the reinforcing fiber bundle.

(13) Evaluation of Wettability of Reinforcing Fiber Bundle with Adhering Sizing Agent

The wettability of a reinforcing fiber bundle with a sizing agent adhering thereto was evaluated using a contact angle meter (manufactured by Kyowa Interface Science Co., Ltd., Model “DM901”). Specifically, in a nitrogen atmosphere, a reinforcing fiber bundle was put in a chamber controlled at a given temperature, and about 3 μL of matrix resin drops were dropped onto it, and the time-dependent change of the contact angle was tracked. By measuring the time taken before the contact angle reached almost equilibrium and the contact angle at the equilibrium-reaching time, the wettability was evaluated. In the case where the matrix was nylon 6, the temperature inside the chamber was set at 280° C.

(14) Evaluation of Adhesion Between Sizing Agent-adhering Reinforcing Fiber Bundle and Matrix Resin

Using a composite material interface characteristic evaluation device HM410 (manufactured by Tohei Sangyo Co., Ltd., adhesiveness was evaluated according to a microdroplet method. A monofilament was taken out of a reinforcing fiber bundle, and set in the composite material interface characteristic evaluation device. Drops of the nylon 6 resin melted on the device were formed on the reinforcing fiber filament and fully cooled at room temperature to give a sample for measurement. The sample for measurement was again set in the device, the drop was sandwiched between the device blades, and the carbon fiber filament was run on the device at a rate of 0.06 mm/min, whereupon the maximum drawing load F in drawing out the drop from the carbon fiber filament was measured. According to the following formula, the interface shear strength τ was calculated, and the adhesiveness between the sized reinforcing fiber filament and the nylon 6 resin was evaluated.

Interface shear strength τ (unit: MPa)=F/πdl

(F: maximum drawing-out load
d: carbon fiber filament diameter
l: particle size of drop in drawing-out direction)

(15) Measurement of Surface Adhesive Force of Reinforcing Fiber Bundle

The surface adhesive force of reinforcing fiber bundles was measured according to the following method, using a tacking tester TAC-II (manufactured by RHESCA Co., Ltd.). In the test method, a reinforcing fiber bundle was set on a test stage held at 120° C., and applying thereto an initial load of 400 gf with a φ10 tack probe held at 120° C., and at a pressing speed of 0.5 mm/sec and for a holding time of 10 seconds, this was drawn off at a test speed of 5 mm/sec to determine the maximum load for the drawing.

(16) Evaluation of Abrasion Resistance of Reinforcing Fiber Bundle (Abrasion Degree MPF)

With a tension of 200 g kept applied thereto, a reinforcing fiber bundle was run between 5 pin guides at a rate of 15.24 m (50 ft)/min for 2 minutes, and then let to pass through two urethane sheets with a weight of 125 g put thereon, and the weight of the reinforcing fibers having remained between the urethane sheets was measured to evaluate the abrasion degree thereof (MPF, in terms of a unit of μg/m).

(17) Measurement of Impregnation Ratio

A matrix resin impregnation ratio into reinforcing fiber bundles was measured according to the following method.

As a sample for measurement, films of nylon 6 having a size of 400 mm in length and 450 mm in width (thickness 30 μm×10 films) were put on an aluminum plate having the same size. Next, the nylon 6 films and the aluminum plate were integrated, and a reinforced fiber bundle widened to 16 mm was wound therearound so as to cover the entire width and so that the reinforcing fiber bundle could form 4 layers in the thickness direction. The reinforcing fiber bundle-wound aluminum plate was set in a hot press at 300° C., and pressed under 0.1 MPa for 5 minutes and 0.15 MPa for 10 minutes. The resultant sample was a composite material in which the fibers were aligned monoaxially and which had a fiber volume content of 50% by volume. These five samples for measurement were prepared.

Next, using a handheld shirring vender (manufactured by CGK Co., Ltd., “BG20-HS”), the center part in the fiber length direction of the resultant composite material was cut off with shears in the direction perpendicular to the fiber axis direction. Using the folding member of this device, a part inside by 10 mm from the part cut off with the shears of the composite material was folded in the direction perpendicular to the fiber axis direction. The folded end part was connected with the unimpregnated reinforcing fibers. The folded end part was drawn off from the main body, and the unimpregnated reinforcing fibers protruding from the composite material body were cut off with scissors.

The operation of taking out the unimpregnated reinforcing fibers was repeated three times for one composite material, and was carried out in a total of 15 times for 5 composite materials. The total weight of the thus collected, unimpregnated reinforcing fibers was measured. The impregnation ratio was calculated from the following formula (1).

Impregnation ratio (%)=100−(total weight of collected unimpregnated reinforcing fibers)/(theoretical amount of reinforcing fiber bundle contained in 450 mm×10 mm of composite material×15) [Formula 1]

(18) Method for Measurement of Bending Property of Reinforcing Fiber Composite Material

From a composite material (shaped plate) containing a reinforcing fiber bundle and a matrix resin, a test piece of 150 mm width×100 mm length was cut out, and the physical properties thereof were evaluated according to a center-loaded three-point bending method of JIS K7074. The test piece was put on the support at r=2 mm with the support spun of 80 mm, and using an indenter with r=5 mm, a load was applied to the center of the support span at a test speed of 5 mm/min, and under the condition, the maximum load and the center deflection amount were measured, and the bending strength (unit, MPa) and the flexural modulus (unit, GPa) were measured.

(19) Method for Measurement of Tensile Property

Using a water jet, a test piece was cut out of a composite material (shaped plate), and according to JIS K7164 (2005) and using a universal tester manufactured by Instron Corporation, the tensile strength and the tensile elastic modulus were measured. The chuck span was 115 mm, and the test speed was 10 mm/min.

### EXAMPLE 1

<Production of Hardly Water-soluble Polymer>

30 kg of a 50% aqueous solution of hexamethyleneammonium adipate, 15 kg of ω-aminoundecanoic acid, and 20 kg of aminododecanoic acid were put in a 70-L autoclave, and the polymerization tank therein was purged with nitrogen, then sealed up and heated up to 170° C., and thereafter with stirring, while the inside of the polymerization tank was controlled under a pressure of 17.5 kgf/cm², the inner temperature of the polymerization tank was elevated up to 230° C. In 1 hour after the polymerization temperature reached 230° C., the polymerization tank was subjected to pressure discharge to normal pressure taking about 1 hour. After pressure discharge, the polymerization was carried out for 1 hour in a nitrogen stream atmosphere, and then further continued under reduced pressure for 1 hour. Nitrogen was introduced to restore the inside to normal pressure, then the stirrer was stopped, and the polymer was taken out as strands and pelletized. Using boiling water, the unreacted monomers were extracted out and the pellets were dried. The copolymerization ratio was nylon 66/nylon 11/nylon 12=30/30/40 (by weight).

<Production of Processing Liquid (Emulsion)>

120 g of the thus-obtained, hardly water-soluble nylon 66/nylon 11/nylon 12 tercopolymer polyamide resin, 179.6 g of water and 0.4 g of sodium hydroxide were put into an autoclave equipped with a stirrer, and heated up to 150° C. while the condition of a rotation number of 500 rpm was kept as such, and under the condition at 150° C., this was reacted for 30 minutes. After the reaction, this was left cooled down to 50° C. as such, and the aqueous polyamide resin dispersion was taken out. The resin concentration of the resultant aqueous polyamide resin dispersion was 40 parts by weight relative to 100 parts by weight of the aqueous dispersion. Water removed from the aqueous dispersion using a hot air drier at 120° C., and the solid content was extracted out by drying in vacuum at the same temperature for 2 hours. The melting point of the tercopolymer polyamide was measured and was 92° C., the surface tension at 250° C. thereof was 31 mN/m, and the 5% weight loss temperature thereof was 303° C. The melt viscosity at 150° C. and at a shear rate of 10 s⁻¹ of the tercopolymer polyamide was 265 Pa·s, and the melt viscosity at 250° C. and at a shear rate of 50 s⁻¹ thereof was 98 Pa·s.

970 parts by weight of distilled water and 0.4 parts by weight of a nonionic surfactant, polyoxyethylene alkyl ether surfactant (polyoxyethylene lauryl ether, manufactured by Kao Corporation, “Emulgen 103”) were added to 50 parts by weight of the above-mentioned aqueous polyamide resin dispersion to prepare a sizing processing liquid. The penetrability of the processing liquid was evaluated. The surfaces of the fiber bundles were immediately wetted, and in about 5 seconds, the fibers sank into the bottom of a 5-cm glass container. Thus, it was confirmed that the penetrability of the processing liquid into the fiber bundles was extremely good. The surface tension of the reinforcing fibers was 42 mN/m.

<Production of Reinforcing Fiber Bundle>

Next, uncut and unprocessed, a flattened reinforcing fiber bundle (carbon fiber bundle, manufactured by Toho Tenax Co., Ltd., “Tenax STS-24K N00”, diameter 7 μm×24000 filaments, width 16 mm, thickness 142 μm) was continuously immersed in a bath of the processing liquid so that the processing liquid was penetrated between the filaments (single fibers) of the fiber bundle. This was dried in a drying furnace at 150° C. for 120 seconds to give a reinforcing fiber bundle having a width of about 13 mm and a thickness of 151 μm. The surface adhesion force at 120° C. of the resultant reinforcing fiber bundle was 14.7 cN (15 gf) and was a low value, and in thermally widening it with a fixed metal bar at the same temperature, the frictional resistance to the metal surface was small. In the continuous test for 1 hour, any melted and softened scum-like resin sump was not observed. The abrasion (MPF) of the reinforcing fiber bundle was somewhat detected to be 738 μg/m (225 μg/ft), but in the same continuous test, no surface fluffing occurred, and the reinforcing fiber bundle was on a practicable level. However, since the texture degree of the reinforcing fiber bundle was high, slight fluffing to a level not causing any problem in production was recognized when the winding part was irradiated with light. The solid adhesion amount of the processing liquid in the resultant reinforcing fiber bundle was 0.5 parts by weight relative to 100 parts by weight of the reinforcing fiber weight, the texture degree of the reinforcing fiber bundle was 112 g, and the convergence power was 4.0 cN (4.1 gf). The impregnation ratio of the reinforcing fiber bundle was evaluated. In microscopic observation, the fiber bundle was broken and opened, and the impregnation ratio was 78% and was extremely good. The wettability for nylon 6 resin was evaluated. The nylon 6 resin balls on the reinforcing fiber bundle achieved equilibrium in about 8 minutes, and the contact angle at that time was 35°. The opening ratio of the reinforcing fiber bundle was 55% and was high, and it was confirmed that the interface adhesion to nylon 6 was 50 MPa and was tough.

<Production of Composite Material>

The reinforcing fiber bundle was cut into 20 mm. A thermoplastic resin to be a matrix (nylon 6 resin powder, manufactured by Unitika Ltd., “A1030FP”) was prepared. These were introduced into a tapered tube under the condition that the feed rate of the reinforcing fiber bundle was 600 g/min and the feed rate of the thermoplastic resin was 730 g/min. The softening point of the thermoplastic resin (nylon 6 resin powder) was 228° C. The surface tension at 250° C. of the thermoplastic resin was 33 mN/m. In the tapered tube, while air blow was applied to the reinforcing fibers to partially open the fiber bundle, the fibers were sprayed onto the table set below the tapered tube outlet port along with the thermoplastic resin powder thereonto. The thus-sprayed reinforcing fibers and thermoplastic resin powder were collected from under the table through suction with a blower, and fixed to give a random mat (fiber resin composition) having a thickness of about 5 mm in which the reinforcing fiber bundles were in-plane oriented randomly.

The resultant random mat was heated under 3 MPa for 5 minutes, using a pressing device heated at 260° C., thereby giving a composite material (fiber-reinforced thermoplastic resin shaped product) having a total fiber/resin areal weight of 2700 g/m², a thickness of 2.0 mm, and a fiber content by volume of 35 vol %. Regarding the surface appearance of the resultant composite material, the fiber bundles and the single fibers were suitably dispersed therein. The surface tension of the tercopolymer nylon and that of the nylon 6 resin powder at the molding temperature 260° C. were 30 mN/m and 32 mN/m, respectively, and the absolute value of the surface tension difference between the tercopolymer nylon and the nylon 6 resin powder was 2 mN/m. No unimpregnated part was detected in the resultant composite material. The tercopolymer nylon had good compatibility with the matrix resin, and the composite material had good bending properties, that is, the bending strength thereof was 498 MPa, and the flexural modulus was 25 GPa.

### EXAMPLE 2

<Production of Hardly Water-soluble Polymer>

A hardly water-soluble tercopolymer polyamide was produced in the same manner as in Example 1, except that ω-aminoundecanoic acid in Example 1 was changed to ε-caprolactam and that the amount of each component to be fed into the 70-L autoclave was changed to 10 kg of ε-caprolactam, 20 kg of a 50% aqueous solution of hexamethyleneammonium adipate and 30 kg of aminododecanoic acid. The copolymerization ratio in the case was nylon 6/nylon 66/nylon 12=20/20/60 (by weight).

<Production of Processing Liquid (Emulsion)>

Using the resultant nylon 6/nylon 66/nylon 12 tercopolymer polyamide resin and according to the same method as in Example 1, an aqueous polyamide resin composition dispersion and a sizing processing liquid were obtained.

The resin concentration of the resultant aqueous polyamide resin dispersion was 40 parts by weight relative to 100 parts by weight of the aqueous dispersion. Under the same condition as in Example 1, water was removed from the aqueous dispersion and the solid content was extracted out. The melting point of the tercopolymer polyamide was 95° C., the surface tension at 250° C. thereof was 31 mN/m, and the 5% weight loss temperature thereof was 304° C. The melt viscosity at 150° C. and at a shear rate of 10 s⁻¹ was 225 Pa·s, and the melt viscosity at 250° C. and at a shear rate of 50 s⁻¹ was 101 Pa·s.

The resultant sizing processing liquid was evaluated for penetrability. The surfaces of the fiber bundles were immediately wetted, and in about 4 seconds, the fibers sank into the bottom of a 5-cm glass container. Thus, it was confirmed that the penetrability of the processing liquid into the fiber bundles was extremely good. The surface tension of the reinforcing fibers was 42 mN/m.

<Production of Reinforcing Fiber Bundle>

Next, using the processing liquid and in the same manner as in Example 1, a reinforcing fiber bundle (carbon fiber bundle) was treated to penetrate the processing liquid between the filaments (single fibers) of the fiber bundle thereby giving a reinforcing fiber bundle having a width of about 13 mm and a thickness of 151 μm. The surface adhesion force at 120° C. of the resultant reinforcing fiber bundle was 16.8 cN (17 gf) and was a low value, and in thermally widening it with a fixed metal bar at the same temperature, the frictional resistance to the metal surface was small. In the continuous test for 1 hour, any melted and softened scum-like resin sump was not observed. The abrasion (MPF) of the reinforcing fiber bundle was somewhat detected to be 705 μg/m (215 μg/ft), but in the same continuous test, no surface fluffing occurred, and the reinforcing fiber bundle was on a practicable level. However, since the texture degree of the reinforcing fiber bundle was high, slight fluffing to a level not causing any problem in production was recognized when the winding part was irradiated with light.

The solid adhesion amount of the processing liquid in the resultant reinforcing fiber bundle was 0.5 parts by weight relative to 100 parts by weight of the reinforcing fiber weight, the texture degree of the reinforcing fiber bundle was 112 g, and the convergence power was 3.7 cN (3.8 gf). The impregnation ratio of the reinforcing fiber bundle was evaluated. In microscopic observation, the fiber bundle was broken and opened, and the impregnation ratio was 80% and was extremely good. The wettability for nylon 6 resin was evaluated. The nylon 6 resin balls on the reinforcing fiber bundle achieved equilibrium in about 8 minutes, and the contact angle at that time was 31°. The opening ratio of the reinforcing fiber bundle was 55% and was high, and it was confirmed that the interface adhesion to nylon 6 was 54 MPa and was tough.

<Production of Composite Material>

The reinforcing fiber bundle was cut into 20 mm. In the same manner as in Example 1, a thermoplastic resin (nylon 6 resin powder) was used as a matrix, and a random mat (fiber resin composition) having a thickness of about 5 mm was obtained, in which the reinforcing fiber bundles were in-plane oriented randomly.

The resultant random mat was heated under 3 MPa for 5 minutes, using a pressing device heated at 260° C., thereby giving a composite material (fiber-reinforced thermoplastic resin shaped product) having a total fiber/resin areal weight of 2700 g/m², a thickness of 2.0 mm, and a fiber content by volume of 35 vol %. Regarding the surface appearance of the resultant composite material, the fiber bundles and the single fibers were suitably dispersed therein. The surface tension of the tercopolymer nylon and that of the nylon 6 resin powder at the molding temperature 260° C. were 30 mN/m and 32 mN/m, respectively, and the absolute value of the surface tension difference between the tercopolymer nylon and the nylon 6 resin powder was 2 mN/m. No unimpregnated part was detected in the resultant composite material. The tercopolymer nylon had good compatibility with the matrix resin, and the composite material had good bending properties, that is, the bending strength thereof was 505 MPa, the flexural modulus was 25 GPa, the tensile strength was 350 MPa, and the tensile elastic modulus was 30 GPa.

### EXAMPLE 3

<Production of Hardly Water-soluble Polymer>

20 kg of ε-caprolactam, 20 kg of a 50% aqueous solution of hexamethyleneammonium adipate, and 20 kg of aminododecanoic acid were put in a 70-L autoclave, and the polymerization tank therein was purged with nitrogen, then sealed up and heated up to 170° C., and thereafter with stirring, while the inside of the polymerization tank was controlled under a pressure of 18.5 kgf/cm², the inner temperature of the polymerization tank was elevated up to 220° C. In 1 hour after the polymerization temperature reached 220° C., the polymerization tank was subjected to pressure discharge to normal pressure taking about 1 hour. After pressure discharge, the polymerization was carried out for 0.5 hours in a nitrogen stream atmosphere, and then further continued under reduced pressure for 1 hour. Nitrogen was introduced to restore the inside to normal pressure, then the stirrer was stopped, and the polymer was taken out as strands and pelletized. Using boiling water, the unreacted monomers were extracted out and the pellets were dried. The copolymerization ratio was nylon 6/nylon 66/nylon 12=40/20/40 (by weight).

<Production of Processing Liquid (Emulsion)>

Using the resultant, hardly water-soluble nylon 6/nylon 66/nylon 12 tercopolymer polyamide resin and according to the same method as in Example 1, an aqueous polyamide resin composition dispersion and a sizing processing liquid were obtained.

The resin concentration of the resultant aqueous polyamide resin dispersion was 40 parts by weight relative to 100 parts by weight of the aqueous dispersion. Under the same condition as in Example 1, water was removed from the aqueous dispersion and the solid content was extracted out. The melting point of the tercopolymer polyamide was 105° C., the surface tension at 250° C. thereof was 32 mN/m, and the 5% weight loss temperature thereof was 311° C. The melt viscosity at 150° C. and at a shear rate of 10 s⁻¹ was 205 Pa·s, and the melt viscosity at 250° C. and at a shear rate of 50 s⁻¹ was 108 Pa·s.

The resultant sizing processing liquid was evaluated for penetrability. The surfaces of the fiber bundles were immediately wetted, and in about 4 seconds, the fibers sank into the bottom of a 5-cm glass container, Thus, it was confirmed that the penetrability of the processing liquid into the fiber bundles was extremely good. The surface tension of the reinforcing fibers was 42 mN/m.

<Production of Reinforcing Fiber Bundle>

Next, using the processing liquid and in the same manner as in Example 1, a reinforcing fiber bundle (carbon fiber bundle) was treated to penetrate the processing liquid between the filaments (single fibers) of the fiber bundle thereby giving a reinforcing fiber bundle having a width of about 13 mm and a thickness of 153 μm. The surface adhesion force at 120° C. of the resultant reinforcing fiber bundle was 17.7 cN (18 gf) and was a low value, and in thermally widening it with a fixed metal bar at the same temperature, the frictional resistance to the metal surface was small. In the continuous test for 1 hour, any melted and softened scum-like resin sump was not observed. The abrasion (MPF) of the reinforcing fiber bundle was 794 μg/m (242 μg/ft), but in the same continuous test, no surface fluffing occurred, and the reinforcing fiber bundle was on a practicable level. However, since the texture degree of the reinforcing fiber bundle was high, slight fluffing to a level not causing any problem in production was recognized when the winding part was irradiated with light.

The solid adhesion amount of the processing liquid in the resultant reinforcing fiber bundle was 0.45 parts by weight relative to 100 parts by weight of the reinforcing fiber weight, the texture degree of the reinforcing fiber bundle was 103 g, and the convergence power was 3.1 cN (3.2 gf). The impregnation ratio of the reinforcing fiber bundle was evaluated. In microscopic observation, the fiber bundle was broken and opened, and the impregnation ratio was 84% and was extremely good. The wettability for nylon 6 resin was evaluated. The nylon 6 resin balls on the reinforcing fiber bundle achieved equilibrium in about 6 minutes, and the contact angle at that time was 27°. The opening ratio of the reinforcing fiber bundle was 57% and was high, and it was confirmed that the interface adhesion to nylon 6 was 58 MPa and was tough.

<Production of Composite Material>

The reinforcing fiber bundle was cut into 20 mm. In the same manner as in Example 1, a thermoplastic resin (nylon 6 resin powder) was used as a matrix, and a random. mat (fiber resin composition) having a thickness of about 5 mm was obtained, in which the reinforcing fiber bundles were in-plane oriented randomly.

The resultant random mat was heated under 3 MPa for 5 minutes, using a pressing device heated at 260° C., thereby giving a composite material (fiber-reinforced thermoplastic resin shaped product) having a total fiber/resin areal weight of 2700 g/m², a thickness of 2.0 mm, and a fiber content by volume of 35 vol %. Regarding the surface appearance of the resultant composite material, the fiber bundles and the single fibers were suitably dispersed therein. The surface tension of the tercopolymer nylon and that of the nylon 6 resin powder at the molding temperature 260° C. were 31 mN/m and 32 mN/m, respectively, and the absolute value of the surface tension difference between the tercopolymer nylon and the nylon 6 resin powder was 1 mN/m. No unimpregnated part was detected in the resultant composite material. The tercopolymer nylon had good compatibility with the matrix resin, and the composite material had good bending properties, that is, the bending strength thereof was 512 MPa and the flexural modulus was 26 GPa.

### EXAMPLE 4

<Production of Water-soluble Polymer>

As an epoxy compound, 3′,4′-epoxycyclohexylmethyl 3,4-epoxycyclohexanecarboxylate (manufactured by Daicel Corporation, Celloxide “CEL-2021P”) was used, and as an amine compound, an amine-terminated polypropylene glycol (manufactured by Huntsman Corporation, “JEFFAMINE D230”) was used. 30.0 parts by weight of the epoxy compound and 35.9 parts by weight of the amine compound were mixed, and then reacted with stirring at 165° C., for 5 hours to give a water-soluble polymer (amine adduct).

On the other hand, the surface tension at 250° C. of the water-soluble polymer was 29 mN/m, and the 5% weight loss temperature thereof was 285° C. The melt viscosity at 150° C. and at a shear rate of 10 s⁻¹ of the water-soluble polymer was 198 Pa·s and the melt viscosity at 250° C. and at a shear rate of 50 s⁻¹ thereof was 58 Pa·s.

<Production of Processing Liquid>

80 parts by weight of the water-soluble polymer ground with a grinder was, with stirring, dropwise added little by little to 1000 parts by weight of carbonic water to prepare a citrine transparent solution. Next, 80 parts by weight of a polyester emulsion (“ES2200” manufactured by DIC Corporation, self-emulsifiable emulsion, solid concentration 25 wt %) was diluted with 940 parts by weight of distilled water, and with stirring, the total amount of aqueous solution of the water-soluble polymer was added thereto to prepare a sizing processing liquid of a mixture of the aqueous solution of the water-soluble polymer and the emulsion (easily water-soluble polymer; 80 parts by weight, hardly water-soluble polymer; 20 parts by weight). The melt viscosity at 150° C. and at a shear rate of 10 s⁻¹ of the solid content obtained by removing water from the polyester emulsion in a hot air drier at 120° C. followed by further drying in vacuum at the same temperature for 2 hours was 382 Pa·s, and the melt viscosity at 250° C. and at a shear rate of 50 thereof was 143 Pa·s. The melt viscosity at 150° C. and at a shear rate of 10 s⁻¹ of the solid content (sizing agent) obtained by removing water from the sizing processing liquid according to the same method was 245 Pa·s, and the melt viscosity at 250° C. and at a shear rate of 50 s⁻¹ thereof was 78 Pa·s. The surface tension of the sizing agent at 250° C. was 30 mN/m, and the 5% weight loss temperature thereof was 292° C. The processing liquid was evaluated for penetrability. The surfaces of the fiber bundles were immediately wetted, and in about 4 seconds, the fibers sank into the bottom of a 5-cm glass container. Thus, it was confirmed that the penetrability of the processing liquid into the fiber bundles was extremely good. The surface tension of the reinforcing fibers was 42 mN/m.

<Production of Reinforcing Fiber Bundle>

Next, using the processing liquid and in the same manner as in Example 1, a reinforcing fiber bundle (carbon fiber bundle, diameter 7 μm×24000 filaments, width 16 mm, thickness 142 μm) was treated to penetrate the processing liquid between the filaments (single fibers) of the fiber bundle thereby giving a reinforcing fiber bundle having a width of about 13 mm and a thickness of 152 μm. The surface adhesion force at 120° C. of the resultant reinforcing fiber bundle was 15.5 cN (15.8 gf) and was a low value, and in thermally widening it with a fixed metal bar at the same temperature, the frictional resistance to the metal surface was small. In the continuous test for 1 hour, any melted and softened scum-like resin sump was not observed. The abrasion (MPF) of the reinforcing fiber bundle was 741 μg/m (226 μg/ft), but in the same continuous test, no surface fluffing occurred, and the reinforcing fiber bundle was on a practicable level. As compared with Comparative Example 2 to be given below, in which a polyester emulsion was not used, the abrasion was a decisively low value.

The solid adhesion amount of the processing liquid in the resultant reinforcing fiber bundle was 0.9 parts by weight relative to 100 parts by weight of the reinforcing fiber weight, the texture degree of the reinforcing fiber bundle was 78 g, and the convergence power was 2.9 cN (3 gf). The texture degree of the reinforcing fiber bundle was low, and when wound, the reinforcing fiber bundle did not break (did not fold). Further, even when the winding part was irradiated with light, no fluffing was recognized, that is, the productivity of the reinforcing fiber bundle was good.

The reinforcing fiber bundle was evaluated for penetrability. In microscopic observation, the fiber bundle was broken and opened, and the impregnation ratio was 80% and was extremely good. The wettability for nylon 6 resin was evaluated. The nylon 6 resin balls on the reinforcing fiber bundle achieved equilibrium in about 9 minutes, and the contact angle at that time was 20°. The opening ratio of the reinforcing fiber bundle was 53% and was high, and it was confirmed that the interface adhesion to nylon 6 was 54 MPa and was tough.

<Production of Composite Material>

The reinforcing fiber bundle was cut into 20 mm. In the same manner as in Example 1, a thermoplastic resin (nylon 6 resin powder) was used as a matrix, and a random mat (fiber resin composition) having a thickness of about 5 mm was obtained, in which the reinforcing fiber bundles were in-plane oriented randomly.

The resultant random mat was heated under 3 MPa for 5 minutes, using a pressing device heated at 260° C., thereby giving a composite material (fiber-reinforced thermoplastic resin shaped product) having a total fiber/resin areal weight of 2700 g/m², a thickness of 2.0 mm, and a fiber content by volume of 35 vol %. Regarding the surface appearance of the resultant composite material, the fiber bundles and the single fibers were suitably dispersed therein. The surface tension of the sizing agent and that of the nylon 6 resin powder at the molding temperature 260° C. were 29 mN/m and 32 mN/m, respectively, and the absolute value of the surface tension difference between the water-soluble polymer and the nylon 6 resin powder was 3 mN/m. No unimpregnated part was detected in the resultant composite material. The water-soluble polymer had good compatibility with the matrix resin, and the composite material had good bending properties, that is, the bending strength thereof was 517 MPa, the flexural modulus was 25 GPa, the tensile strength was 375 MPa, and the tensile elastic modulus was 32 GPa.

### EXAMPLE 5

<Production of Hardly Water-soluble Polymer>

10 kg of ε-caprolactam, 20 kg of a 50% aqueous solution of hexamethyleneammonium adipate, and 30 kg of aminododecanoic acid were put in a 70-L autoclave, and the polymerization tank therein was purged with nitrogen, then sealed up and heated up to 180° C., and thereafter with stirring, while the inside of the polymerization tank was controlled under a pressure of 17.5 kgf/cm², the inner temperature of the polymerization tank was elevated up to 240° C. In 1 hour after the polymerization temperature reached 240° C., the polymerization tank was subjected to pressure discharge to normal pressure taking about 2 hours. After pressure discharge, the polymerization was carried out for 2 hours in a nitrogen stream atmosphere, and then further continued under reduced pressure for 2 hours. Nitrogen was introduced to restore the inside to normal pressure, then the stirrer was stopped, and the polymer was taken out as strands and pelletized. Using boiling water, the unreacted monomers were extracted out and the pellets were dried. The copolymerization ratio was nylon 6/nylon 66/nylon 12=20/20/60 (by weight), and the composition ratio was the same as that of the hardly water-soluble polyamide in Example 2, but the polymer had a higher molecular weight.

<Production of Processing Liquid (Emulsion)>

Using the resultant nylon 6/nylon 66/nylon 12 tercopolymer polyamide resin and according to the same method as in Example 1, an aqueous polyamide resin composition dispersion was obtained.

The resin concentration of the resultant aqueous polyamide resin dispersion was 40 parts by weight relative to 100 parts by weight of the aqueous dispersion. Under the same condition as in Example 1, water was removed from the aqueous dispersion and the solid content was extracted out. The melting point of the tercopolymer polyamide was 104° C., the surface tension at 250° C. thereof was 31 mN/m, and the 5% weight loss temperature thereof was 314° C. The melt viscosity at 150° C. and at a shear rate of 10 s⁻¹ was 311 Pa·s, and the melt viscosity at 250° C. and at a shear rate of 50 s⁻¹ was 202 Pa·s.

The sizing processing liquid was obtained by adding distilled water and a nonionic surfactant to the aqueous polyamide resin dispersion in the same manner as in Example 1.

Next, 16 parts by weight of a polyurethane emulsion (“HW0940” manufactured by DIC Corporation, self-emulsifiable emulsion, solid concentration 35 wt %) was gradually added to the sizing processing solution of the polyamide resin with stirring to give a sizing processing solution of a mixture of polyamide (hardly water-soluble polymer; 20 parts by weight) and polyurethane (easily water-soluble polymer; 5.6 parts). The melt viscosity at 150° C. and at a shear rate of 10 s⁻¹ of the solid content obtained by removing water from the polyurethane emulsion in a hot air drier at 120° C. followed by further drying in vacuum at the same temperature for 2 hours was 205 Pa·s, the melt viscosity at 250° C. and at a shear rate of 50 s⁻¹ thereof was 68 Pa·s, and the surface tension at 250° C. was 29 mN/m.

The melt viscosity at 150° C. and at a shear rate of 10 s⁻¹ of the solid content (sizing agent) obtained by removing water from the sizing processing liquid according to the same method was 245 Pa·s, and the melt viscosity at 250° C. and at a shear rate of 50 s⁻¹ thereof was 98 Pa·s. The surface tension of the sizing agent at 250° C. was 30 mN/m, and the 5% weight loss temperature thereof was 305° C. The processing liquid was evaluated for penetrability. The surfaces of the fiber bundles were immediately wetted, and in about 4 seconds, the fibers sank into the bottom of a 5-cm glass container. Thus, it was confirmed that the penetrability of the processing liquid into the fiber bundles was extremely good. The surface tension of the reinforcing fibers was 42 mN/m.

<Production of Reinforcing Fiber Bundle>

Next, using the processing liquid and in the same manner as in Example 1, a reinforcing fiber bundle (carbon fiber bundle) was treated to penetrate the processing liquid between the filaments (single fibers) of the fiber bundle thereby giving a reinforcing fiber bundle having a width of about 13 mm and a thickness of 152 μm. The surface adhesion force at 120° C. of the resultant reinforcing fiber bundle was 18.6 cN (19 gf) and was a low value, and in thermally widening it with a fixed metal bar at the same temperature, the frictional resistance to the metal surface was small. In the continuous test for 1 hour, any melted and softened scum-like resin sump was not observed. The abrasion (MPF) of the reinforcing fiber bundle was 256 μg/m (78 μg/ft) and was an extremely low value. Further, in the same continuous test, no surface fluffing was recognized.

The solid adhesion amount of the processing liquid in the resultant reinforcing fiber bundle was 0.48 parts by weight relative to 100 parts by weight of the reinforcing fiber weight, the texture degree of the reinforcing fiber bundle was 42 g, that is, the fiber bundle was extremely soft, and the convergence power was 3.8 cN (3.9 gf). The reinforcing fiber bundle was evaluated for penetrability. In microscopic observation, the fiber bundle was broken and opened, and the impregnation ratio was 86% and was extremely good. The wettability for nylon 6 resin was evaluated. The nylon 6 resin balls on the reinforcing fiber bundle achieved equilibrium in about 7 minutes, and the contact angle at that time was 30°. The opening ratio of the reinforcing fiber bundle was 54% and was high, and it was confirmed that the interface adhesion to nylon 6 was 55 MPa and was tough.

The resultant reinforcing fiber bundle did not fluff at all by abrasion, and the texture degree thereof was low. Consequently, when wound up, the reinforcing fiber bundle did not break (did not fold), Even when the winding part was irradiated with light, no fluffing was recognized at all, that is, the productivity of the reinforcing fiber bundle was especially good.

<Production of Composite Material>

The reinforcing fiber bundle was cut into 20 mm. In the same manner as in Example 1, a thermoplastic resin (nylon 6 resin powder) was used as a matrix, and a random mat (fiber resin composition) having a thickness of about 5 mm was obtained, in which the reinforcing fiber bundles were in-plane oriented randomly.

The resultant random mat was heated under 3 MPa for 5 minutes, using a pressing device heated at 260° C., thereby giving a composite material (fiber-reinforced thermoplastic resin shaped product) having a total fiber/resin areal weight of 2700 g/m², a thickness of 2.0 mm, and a fiber content by volume of 35 vol %. Regarding the surface appearance of the resultant composite material, the fiber bundles and the single fibers were suitably dispersed therein. The surface tension of the sizing agent and that of the nylon 6 resin powder at the molding temperature 260° C. were 29 mN/m and 32 mN/m, respectively, and the absolute value of the surface tension difference between the tercopolymer nylon and the nylon 6 resin powder was 3 mN/m. No unimpregnated part was detected in the resultant composite material. The sizing agent had good compatibility with the matrix resin, and the composite material had good bending properties, that is, the bending strength thereof was 506 MPa, the flexural modulus was 25 GPa, the tensile strength was 378 MPa, and the tensile elastic modulus was 33 GPa.

### EXAMPLE 6

<Production of Processing Liquid (Emulsion)>

963 parts by weight of distilled water and 0.4 parts by weight of a nonionic surfactant, polyoxyethylene alkyl ether surfactant (polyoxyethylene lauryl ether, manufactured by Kao Corporation, “Emulgen 103”) were added to 57 parts by weight of a polyurethane emulsion (“HW0940” manufactured by DIC corporation, self-emulsifiable emulsion, solid concentration 35% by weight) to prepare a sizing processing liquid.

<Production of Reinforcing Fiber Bundle>

Next, using the processing liquid and in the same manner as in Example 1, a reinforcing fiber bundle (carbon fiber bundle) was treated to penetrate the processing liquid between the filaments (single fibers) of the fiber bundle thereby giving a reinforcing fiber bundle having a width of about 13 mm and a thickness of 150 μm. The surface adhesion force at 120° C. of the resultant reinforcing fiber bundle was 22.6 cN (23 gf) and was a low value, and in thermally widening it with a fixed metal bar at the same temperature, the frictional resistance to the metal surface was small. In the continuous test for 1 hour, any melted and softened scum-like resin sump was not observed. The abrasion (MPF) of the reinforcing fiber bundle was 20 μg/m (26 μg/ft) and was an extremely low value. Further, in the same continuous test, no surface fluffing was recognized.

The solid adhesion amount of the processing liquid in the resultant reinforcing fiber bundle was 0.52 parts by weight relative to 100 parts by weight of the reinforcing fiber weight, the texture degree of the reinforcing fiber bundle was 28 g, that is, the fiber bundle was extremely soft, and the convergence power was 3.8 cN (3.9 gf). The reinforcing fiber bundle was evaluated for penetrability. In microscopic observation, the fiber bundle was broken and opened, and the impregnation ratio was 82% and was extremely good. The wettability for nylon 6 resin was evaluated. The nylon 6 resin balls on the reinforcing fiber bundle achieved equilibrium in about 9 minutes, and the contact angle at that time was 33°. The opening ratio of the reinforcing fiber bundle was 62% and was high, and it was confirmed that the interface adhesion to nylon 6 was 50 MPa and was tough.

The resultant reinforcing fiber bundle did not fluff by abrasion, and the texture degree thereof was low. Consequently, when wound up, the reinforcing fiber bundle did not break (did not fold). Even when the winding part was irradiated with light, no fluffing was recognized at all, that is, the productivity of the reinforcing fiber bundle was especially good.

<Production of Composite Material>

The reinforcing fiber bundle was cut into 20 mm. In the same manner as in Example 1, a thermoplastic resin (nylon 6 resin powder) was used as a matrix, and a random mat (fiber resin composition) having a thickness of about 5 mm was obtained, in which the reinforcing fiber bundles were in-plane oriented randomly. However, as compared with that in the other Examples, the random mat was bulky, in which the amount of the single fibers was somewhat large and the reinforcing fiber bundle somewhat folded.

The resultant random mat was heated under 3 MPa for 5 minutes, using a pressing device heated at 260° C., thereby giving a composite material (fiber-reinforced thermoplastic resin shaped product) having a total fiber/resin areal weight of 2700 g/m², a thickness of 2.0 mm, and a fiber content by volume of 35 vol %. Regarding the surface appearance of the resultant composite material, the amount of the single fibers was somewhat large therein. The surface tension of the polyurethane and that of the nylon 6 resin powder at the molding temperature 260° C. were 28 mN/m and 32 mN/m, respectively, and the absolute value of the surface tension difference between the polyurethane and the nylon 6 resin powder was 4 mN/m. As the random mat was bulky, some but slight unimpregnated parts were detected in the resultant composite material. Regarding the bending properties of the composite material, the bending strength thereof was 452 MPa and the flexural modulus was 23 GPa. These were somewhat low, but were on a practicable level.

### Comparative Example 1

<Production of Hardly Water-soluble Polymer>

Using the same composition as in Example 1 but the condition for the processing temperature was elevated, a hardly water-soluble polymer was produced. Concretely, an aqueous solution of hexamethyleneammonium adipate, ω-aminoundecanoic acid and aminododecanoic acid were fed, the polymerization tank was purged with nitrogen, then sealed up, and heated up to 180° C. Next, with stirring and while the inside of the polymerization tank was controlled at 17.5 kf/cm², the temperature inside the polymerization tank was elevated up to 240° C. In 2 hours after the polymerization temperature reached 240° C., the pressure inside the polymerization tank was discharged to normal pressure taking about 2 hours. After pressure discharge, the polymerization was carried out for 1 hour in a nitrogen stream atmosphere, and then further continued under reduced pressure for 2 hours. Nitrogen was introduced to restore the inside to normal pressure, then the stirrer was stopped, and the polymer was taken out as strands and pelletized. Using boiling water, the unreacted monomers were extracted out and the pellets were dried. The copolymerization ratio was nylon 66/nylon 11/nylon 12=30/30/40 (by weight).

<Production of Processing Liquid (Emulsion)>

Using the resultant nylon 66/nylon 11/nylon 12 tercopolymer polyamide resin and under the same condition as in Example 1, an aqueous polyamide resin composition dispersion and a sizing processing liquid were obtained. The resin concentration of the resultant aqueous polyamide resin dispersion was 40 parts by weight relative to 100 parts by weight of the aqueous dispersion. Under the same condition as in Example 1, water was removed from the aqueous dispersion and the solid content was extracted out. The melting point of the tercopolymer polyamide was 105° C., the surface tension at 250° C. thereof was 31 mN/m, and the 5% weight loss temperature thereof was 315° C. The melt viscosity at 150° C. and at a shear rate of 10 s⁻¹ of the tercopolymer polyamide was 328 Pa·s, and the melt viscosity at 250° C. and at a shear rate of 50 s⁻¹ thereof was 203 Pa·s.

The sizing processing liquid was evaluated for penetrability. The surfaces of the fiber bundles were immediately wetted, and in about 5 seconds, the fibers sank into the bottom of a 5-cm glass container. Thus, it was confirmed that the penetrability of the processing liquid into the fiber bundles was extremely good. The surface tension of the reinforcing fibers was 42 mN/m.

<Production of Reinforcing Fiber Bundle>

Next, using the processing liquid and in the same manner as in Example 1, a reinforcing fiber bundle (carbon fiber bundle) was treated to penetrate the processing liquid between the filaments (single fibers) of the fiber bundle thereby giving a reinforcing fiber bundle having a width of about 13 mm and a thickness of 155 μm. The surface adhesion force at 120° C. of the resultant reinforcing fiber bundle was 14.7 cN (15 gf) and was a low value, and in thermally widening it with a fixed metal bar at the same temperature, the frictional resistance to the metal surface was small. In the continuous test for 1 hour, any melted and softened scum-like resin sump was not observed. The abrasion (MPF) of the reinforcing fiber bundle was 787 μg/m (240 μg/ft), and in the same continuous test, little surface fluffing was recognized, that is, the reinforcing fiber bundle was on a practicable level.

The solid adhesion amount of the processing liquid in the resultant reinforcing fiber bundle was 0.6 parts by weight relative to 100 parts by weight of the reinforcing fiber weight, the texture degree of the reinforcing fiber bundle was 140 g, and the convergence power was 5 cN (4.9 gf). The reinforcing fiber bundle was evaluated for penetrability. The degree of breakage and opening of the fiber bundle was extremely low, and the impregnation ratio was 31% and was low. Consequently, the fiber bundle was not shaped into a composite material.

### (Comparative Example 2

<Production of Water-soluble Polymer>

80 parts by weight of the water-soluble polymer (amine adduct) of Example 4 ground with a grinder was, with stirring, dropwise added little by little to 1000 parts by weight of carbonic water to prepare a citrine transparent solution. The aqueous solution was used as a processing liquid for sizing. The processing liquid was evaluated for penetrability. The surfaces of the fiber bundles were immediately wetted, and in about 5 seconds, the fibers sank into the bottom of a 5-cm glass container. Thus, it was confirmed that the penetrability of the processing liquid into the fiber bundles was extremely good.

<Production of Reinforcing Fiber Bundle>

Next, using the processing liquid and in the same manner as in Example 1, a reinforcing fiber bundle (carbon fiber bundle) was treated to penetrate the processing liquid between the filaments of the fiber bundle thereby giving a reinforcing fiber bundle having a width of about 13 mm and a thickness of 155 μm. The solid adhesion amount of the processing liquid in the resultant reinforcing fiber bundle was 1.2 parts by weight relative to 100 parts by weight of the reinforcing fiber weight, the texture degree of the reinforcing fiber bundle was 28 g, and the convergence power was 0.88 cN (0.9 gf), and these values were all extremely low. The surface adhesion force at 120° C. of the fiber bundle was 36.7 cN (37.4 gf) and was higher than that in Example 1, and in thermally widening it with a fixed metal bar at the same temperature, the frictional resistance to the metal surface was large. In the continuous test for 1 hour, melted and softened scum-like resin sump was observed. Further, the abrasion (MPF) of the reinforcing fiber bundle was 3214 μg/m (1010 μg/ft) and was extremely high, and in the same continuous test, surface fluffing occurred noticeably. In addition, the opening ratio of the reinforcing fiber bundle was 91% and was extremely high, and the fiber bundle was bulky as containing a large amount of single fibers.

<Production of Composite Material>

The reinforcing fiber bundle was cut into 20 mm. In the same manner as in Example 1, a thermoplastic resin (nylon 6 resin powder) was used as a matrix, and a random mat (fiber resin composition) having a thickness of about 5 mm was obtained, in which the reinforcing fiber bundles were in-plane oriented randomly. However, as compared with that in Example 1 and others, the random mat (fiber resin composition) was bulky since the amount of single fibers therein was large, in which the reinforcing fiber bundles and the single fibers were randomly oriented not only in the in-plane direction but also in the thickness direction.

The resultant random mat was heated under 3 MPa for 5 minutes, using a pressing device heated at 260° C., thereby giving a composite material (fiber-reinforced thermoplastic resin shaped product) having a total fiber/resin areal weight of 2700 g/m², a thickness of 2.0 mm, and a fiber content by volume of 35 vol %. Regarding the surface appearance of the resultant composite material, the amount of the single fibers in the surface was extremely large. The surface tension of the water-soluble polymer and that of the nylon 6 resin powder at the molding temperature 260° C. were 31 mN/m and 32 mN/m, respectively, and the absolute value of the surface tension difference between the water-soluble polymer and the nylon 6 resin powder was 1 mN/m. Regarding the composite material, the random mat thereof was bulky, and therefore some unimpregnated parts were observed in places. Regarding the binding properties of the composite material, the bending strength thereof was 328 MPa, the flexural modulus was 16 GPa, the tensile strength was 254 MPa, and the tensile elastic modulus was 18 GPa, and these values were low.

### (Comparative Example 3

<Production of Processing Liquid>

30 parts by weight of the water-soluble polymer produced in Example 4 and ground with a grinder was, with stirring, dropwise added little by little to 1000 parts by weight of carbonic water to prepare a citrine transparent solution. Next, 280 parts by weight of the polyester emulsion (“ES2200” manufactured by DIC Corporation, solid concentration 25 wt %) was diluted with 2790 parts by weight of distilled water, and then with stirring, the total amount of the aqueous water-soluble polymer solution was added thereto to prepare a sizing processing liquid of a mixture of the aqueous water-soluble polymer and the emulsion (easily water-soluble polymer; 30 parts by weight, hardly water-soluble polymer; 70 parts by weight). The melt viscosity at 150° C. and at a shear rate of 10 s⁻1 of the solid content obtained by removing water from the sizing processing liquid in a hot air drier at 120° C. followed by further drying in vacuum at the same temperature for 2 hours was 325 Pa·s, and the melt viscosity at 250° C. and at a shear rate of 50 s⁻¹ thereof was 118 Pa·s. The surface tension of the sizing agent at 250° C. was 30 mN/m, and the 5% weight loss temperature thereof was 311° C. The processing liquid was evaluated for penetrability. The surfaces of the fiber bundles were immediately wetted, and in about 4 seconds, the fibers sank into the bottom of a 5-cm glass container. Thus, it was confirmed that the penetrability of the processing liquid into the fiber bundles was extremely good. The surface tension of the reinforcing fibers was 42 mN/m.

<Production of Reinforcing Fiber Bundle>

Next, using the processing liquid and in the same manner as in Example 1, a reinforcing fiber bundle (carbon fiber bundle, diameter 7 μm×24000 filaments, width 16 mm, thickness 142 μm) was treated to penetrate the processing liquid between the filaments (single fibers) of the fiber bundle thereby giving a reinforcing fiber bundle having a width of about 13 mm and a thickness of 152 μm. The surface adhesion force at 120° C. of the resultant reinforcing fiber bundle was 13.7 cN (14.0 gf) and was a low value, and in thermally widening it with a fixed metal bar at the same temperature, the frictional resistance to the metal surface was small. In the continuous test for 1 hour, any melted and softened scum-like resin sump was not observed. The abrasion (MPF) of the reinforcing fiber bundle was 761 μg/m (232 μg/ft), and in the same continuous test, little surface fluffing occurred, and the reinforcing fiber bundle was on a practicable level.

The solid adhesion amount of the processing liquid in the resultant reinforcing fiber bundle was 0.52 parts by weight relative to 100 parts by weight of the reinforcing fiber weight, the texture degree of the reinforcing fiber bundle was 118 g, and the convergence power was 5.1 cN (5.2 gf). The reinforcing fiber bundle was evaluated for penetrability. The degree of breakage and opening of the fiber bundle was extremely low, and the impregnation ratio was 36% and was low. Consequently, the fiber bundle was not shaped into a composite material.

### Comparative Example 4

<Production of Processing Liquid (Emulsion)>

6217.6 parts by weight of distilled water and 0.4 g of a nonionic surfactant, polyoxyethylene alkyl ether surfactant (polyoxyethylene lauryl ether, manufactured by Kao Corporation, “Emulgen 103”) were added to 237.5 parts by weight of the aqueous dispersion of nylon 6/nylon 66/nylon 12 tercopolymer polyamide resin used in Example 5, to prepare a sizing processing liquid.

Next, 14.3 parts by weight of the polyurethane emulsion (“HW0940” manufactured by DIC Corporation, solid concentration 35 wt %) used in Example 5 was gradually added to the sizing processing solution of polyamide resin kept stirred, thereby giving a sizing processing liquid of a mixture of polyamide (hardly water-soluble polymer; 95 parts by weight) and polyurethane (easily water-soluble polymer; 5 parts), The melt viscosity at 150° C. and at a shear rate of 10 s⁻¹ of the solid content obtained by removing water from the sizing processing liquid in a hot air drier at 120° C. followed by further drying in vacuum at the same temperature for 2 hours was 306 Pa·s, the melt viscosity at 250° C. and at a shear rate of 50 s⁻¹ thereof was 201 Pa·s, the surface tension at 250° C. was 31 mN/m, and the 5% weight loss temperature was 318° C. The processing liquid was evaluated for penetrability. The surfaces of the fiber bundles were immediately wetted, and in about 4 seconds, the fibers sank into the bottom of a 5-cm glass container. Thus, it was confirmed that the penetrability of the processing liquid into the fiber bundles was extremely good. The surface tension of the reinforcing fibers was 42 mN/m.

<Production of reinforcing fiber bundle>

Next, using the processing liquid and in the same manner as in Example 1, a reinforcing fiber bundle (carbon fiber bundle) was treated to penetrate the processing liquid between the filaments (single fibers) of the fiber bundle thereby giving a reinforcing fiber bundle having a width of about 13 mm and a thickness of 152 μm. The surface adhesion force at 120° C. of the resultant reinforcing fiber bundle was 15.7 cN (16 gf) and was a low value, and in thermally widening it with a fixed metal bar at the same temperature, the frictional resistance to the metal surface was small. In the continuous test for 1 hour, any melted and softened scum-like resin sump was not observed. The abrasion (MPF) of the reinforcing fiber bundle was 650 μg/m (198 μg/ft), and in the same continuous test, little surface fluffing occurred, and the reinforcing fiber bundle was on a practicable level.

The solid adhesion amount of the processing liquid in the resultant reinforcing fiber bundle was 0.46 parts by weight relative to 100 parts by weight of the reinforcing fiber weight, the texture degree of the reinforcing fiber bundle was 134 g, and the convergence power was 4.2 cN (4.3 gf). The reinforcing fiber bundle was evaluated for penetrability. The degree of breakage and opening of the fiber bundle was extremely low, and the impregnation ratio was 37% and was low. Consequently, the fiber bundle was not shaped into a composite material.

1. A reinforcing fiber bundle with a sizing agent adhering to a surface thereof,
wherein the sizing agent comprises a thermoplastic resin as a main component and an emulsion or a dispersion, and
wherein a melt viscosity of a solid content of the sizing agent at 150° C. and at a shear rate of 10 s⁻¹ is 50 to 300 Pa·s.

2. The reinforcing fiber bundle according to claim 1, wherein the melt viscosity of the solid content of the sizing agent at 250° C. and at a shear rate of 50 s⁻¹ is 10 to 200 Pa·s.

3. The reinforcing fiber bundle according to claim 1, wherein the sizing agent contains a water-soluble polymer.

4. The reinforcing fiber bundle according to claim 1, wherein the sizing agent contains particles of an emulsion or dispersion-derived polymer component.

5. The reinforcing fiber bundle according to claim 1, wherein the reinforcing fiber bundle is a carbon fiber bundle.

6. The reinforcing fiber bundle according to claim 1, wherein the solid content of the sizing agent is a mixture of two or more polymers, and contains at least one or more hardly water-soluble polymers.

7. A method for producing a reinforcing fiber bundle, comprising adhering a processing liquid, in which a melt viscosity of a solid content at 150° C. is 50 to 300 Pa·s and which contains an emulsion or a dispersion, to the surface of a fiber bundle constituted by reinforcing fibers, and drying the processing liquid.

8. A processing liquid for reinforcing fibers, in which a melt viscosity of a solid content at 150° C. is 50 to 300 Pa·s and which comprises an emulsion or a dispersion.

9. A processing liquid for reinforcing fibers, comprising a water-soluble polymer, and an emulsion or a dispersion.

10. A composite material comprising reinforcing fibers obtained from a reinforcing fiber bundle of claim 1, and a matrix resin.
